(19) United States
(12) Patent Application Publication
(10) Pub. No.: US 2003/0135565 A1
(43) Pub. Date: Jul. 17, 2003

(54) Electronic mail application with integrated collaborative space management

(76) Inventor: Julio Estrada, Concord, MA (US)

Correspondence Address: MINTZ LEVIN COHN FERRIS GLOVSKY AND POPEO PC, 12010 SUNSET HILLS ROAD, SUITE 900, RESTON, VA, 20190, US

(21) Appl. No.: 10/093,713

(22) Filed: Mar. 11, 2002

Related U.S. Application Data
(60) Provisional application No. 60/347,236, filed on Jan. 14, 2002.

(51) Int. Cl. G06F 15/16

(52) U.S. Cl. 709/206

(57) ABSTRACT

A system and method for providing an electronic mail application with integrated collaborative spaces. A user may use an electronic mail application to create a project that enables collaboration with a plurality of users. The user may request that a new project be created using the electronic mail application. A project folder may be created in the user's mailbox. The project folder may include a project calendar, files folder, participants list, and tasks folder. The user may invite other users to be participants in the project. This may be performed by creating an invitation electronic mail message that includes a link for creating and retrieving the project. The invitation message may be sent to a plurality of users. The users may receive the invitation message and accept, decline or otherwise respond to the invitation to join the project. If the user accepts the invitation, a project folder for that project may be created in the user's mailbox. The system monitors project activities and updates each user's project folder accordingly. For example, electronic mail messages sent regarding the project may appear in the projects folder inbox as well as the electronic mail application inbox. The messages stored in the projects folder inbox may be provided with identifying information that enables the system to associate the messages within the context of the project. Therefore, all messages associated with a particular project task may be displayed as a list in the order in which the messages were received to provide contextual information regarding the messages.

### CROSS-REFERENCE TO RELATED APPLICATIONS

This Application claims priority from U.S. Provisional Patent Application Serial No. 60/347,236, filed Jan. 14, 2002, which is incorporated herein by reference.

### BACKGROUND OF THE INVENTION

Electronic mail applications that enable a user to transmit and receive electronic mail are known. Email applications often include user mailboxes. Each user's mailbox may be pre-configured by the system to have one or more folders, such as an inbox, an outbox, a sent items folder, a deleted items folder and other pre-configured folders. These folders typically have pre-assigned names that the user can not change. Additionally, users may create and name personal folders within the mailbox. When a user receives an email message, the message typically comes into the users inbox. The user can view the message and perform a variety of actions, including responding, deleting, moving to a personal folder or other actions.

Electronic mail is a form of unstructured electronic communication consisting primarily of a message exchange between a message creator and one or more recipients. Electronic mail may be considered unstructured because the contents of the message are free-form. In other words, there may be no imposed, pre-determined structure or schema, and the message may lack information as to its spatial or organizational context outside of the message itself (e.g., an activity or project it relates to). In addition, there may be no processing logic associated with a message. Messaging is the infrastructure (e.g., standard protocols, mail gateways, mailbox repositories, mail user agents) that supports electronic mail.

Some electronic mail applications are integrated with personal information managers such as, for example, Lotus Notes™ and Microsoft Outlook™. The personal information managers may also provide other functionalities such as electronic calendars, task lists, and address book. The personal information managers may be used in conjunction with a known collaboration application (e.g., Microsoft Sharepoint Team Services™, or Lotus QuickPlace™) for coordinating the sharing of information (e.g. messages in an electronic discussion forum, tasks, calendar events, and files) related to a project or activity among various users.

Collaboration generally relates to electronic communications around an activity or project between two or more individuals. Collaboration may be considered structured because it typically presents the notion of a team (e.g., a group of individuals engaged in an activity). It further presents the notion of a space where information is stored and shared; it is purposeful; and it imposes some level of organization with respect to the team, the space, and its contents. Collaboration may further present some notion of goals and objectives, and often supports business processes around the interaction of individuals, and the sharing and processing of information.

Despite the evolution of collaborative software and the rapid growth of the Internet, the vast majority of organizations are still unable to spontaneously collaborate with one another in an organized, secured manner. Virtually all businesses, however, spontaneously communicate via unstructured, unsecured email. While messaging and collaboration are different, they are, at a core level, essentially the same. For example, messaging and collaboration are about communicating information with other individuals, and both deal with messages, folders, calendar events, tasks, and contacts. Yet collaboration, being perceived as a different problem, has been implemented and offered separately from messaging. This artificial separation has resulted in the implementation of different collaboration infrastructures, which have not been widely adopted. This presents difficulties to businesses attempting to spontaneously collaborate with one another. Moreover, the collaborative environment of individuals are often fragmented, meaning that messages, folders, calendars, tasks, and contacts may be dispersed across project spaces and the inbox, making it difficult for a user to consolidate while inefficiently switching between messaging and collaboration.

Additionally, messages received by a user are typically placed in the user's electronic mail application inbox only. The user may then move the messages to, for example, a user created personal folder for a particular topic. The messages, however, are generally organized according to one of date/time received, sender, or subject. Therefore, the messages are often grouped in a manner that may not provide little if any context with respect to other related messages.

Some collaboration applications use email messaging to notify a participant that new items have been added to the collaborative work space. Typically, however, the participant must switch from an electronic mail application to the collaborative workspace application to view the new items. In part this is because the collaborative workspace items are stored in the collaborative workspace environment, not in the users email application. This is but one inefficiency of existing applications. These and other drawbacks exist.

### SUMMARY OF THE INVENTION

The invention solving these and other problems relates to a system and method for providing a computer-implemented electronic mail application system comprising an electronic mail module and an integrated collaborative workspace module.

According to an embodiment of the invention, a user's electronic mail module preferably includes a user mailbox. In some embodiments, the electronic mail application may integrated with a personal information manager (PIM).

The collaborative workspace module may enable a user to create and view a collaborative workspace in their electronic mail application, preferably in their user mailbox. This collaborative workspace may comprise, for example, a collaborative workspace folder (or project folder) that is created in the user's mailbox. The collaborative workspace may further comprise a number of collaborative object types, and the collaborative workspace module may create one or more sub-folders in the collaborative workspace folder that correspond to each of the collaborative object types.

Examples of collaborative object types may include one or more of electronic mail messages, a calendar, tasks, discussions, documents, participants, or other object types. The user may selectively view the collaborative workspace by object type.

According to one embodiment of the invention, various templates may be used to facilitate the creation of different types of projects, and to specify the type of objects (and properties of the objects) that should be included based on the particular type of project.

According to one embodiment of the invention, a collaborative workspace calendar object may be provided wherein a user can view the collaborative workspace calendar events in a calendar view. The calendar object may be viewed simultaneously with a user's personal (PIM) calendar view. A user may further elect to have the user's personal calendar view display both personal and collaborative workspace calendar object events. The system may further comprise visual or other indicators to differentiate between workspace calendar object events for different projects, and/or between workspace calendar object events and personal calendar events.

According to one embodiment of the invention, a collaborative workspace participants object may be provided wherein a user can view the collaborative workspace participants objects in a participants view. Additionally, a user may, if desired, simultaneously view a collaborative workspace participants view as well as personal contacts associated with their PIM. In the collaborative workspace participants view, a user can selectively display project participants information including participant status, participants postings information and other participant information. The system can have visual or other indicators to differentiate between different participants and/or between participants and personal contacts in PIM contacts view.

According to one embodiment of the invention, a collaborative workspace tasks object may be provided wherein a user can view collaborative workspace tasks objects in a tasks view. Preferably, a user may simultaneously view a collaborative workspace tasks view as well as personal tasks associated with their PIM. In the collaborative tasks view, a user may selectively display project tasks information including task status, responsibility and other tasks information. The system may also have visual or other indicators to differentiate between different tasks and/or between project tasks and personal tasks in tasks view.

According to another aspect of the invention, the collaborative workspace module may enable a first user to invite one or more other users to participate in a collaborative workspace project. The invitation may be sent via email by the first users email module. According to another aspect of the invention, when a first user invites another user, the collaborative workspace module may send the invited participant information to enable the collaborative work space module to be integrated with the invited participant's electronic mail application, if the invited participant accepts the invitation and the collaborative work space module has not previously been integrated with the invited participant s electronic mail application. Various advantages of this will be apparent.

One advantageous aspect of this feature is that it creates a viral marketing component to the system in addition to a number of functional benefits some of which are detailed below. The invitation may include a link to a location that enables a participant to download a collaborative workspace module.

According to an embodiment of the invention, an invited participant's electronic mail module preferably also includes a user mailbox, and the collaborative workspace module is operable, in response to the invited participant accepting an invitation to participate in the collaborative workspace, for creating a folder for the collaborative workspace in the invitee's user mailbox. Preferably, the folder created in the first user mailbox has a folder name, and the folder for the collaborative workspace created in the invitee's mailbox is automatically created with the same folder name. Among other things, this facilitates the synchronization of folders among all participants, as discussed in detail below.

According to another embodiment of the invention, the collaborative workspace module may synchronize or replicate the collaborative workspace folder created in the first user's mailbox into the electronic mail application of those invitee's that have accepted the invitation to join the project. The collaborative workspace module further includes means for monitoring content in the shared collaborative workspace such that changes to the content made by any user will he propagated into the shared collaborative workspace of other participating users.

According to another embodiment of the invention, even when a first user has an electronic mail application of a first type and a second, invited user has an electronic mail application of a second type, the collaborative workspace module enables the first user to see the collaborative workspace in the first type electronic mail application environment and the second user to see the collaborative workspace in the second type electronic mail application environment. The first and second electronic mail applications may include any number of electronic mail applications, including Lotus Notes, Microsoft Outlook, AOL Mail, or others.

According to another embodiment of the invention, the electronic mail application of a collaborative workspace participant may include an inbox within the user mailbox. One feature provided by the invention is the ability of a participant to view electronic mail messages associated with a collaborative workspace project simultaneously in both their inbox, and in the collaborative workspace folder view of the collaborative work space module. Preferably, the collaborative workspace folder view displays the electronic mail message in the context of other activity of the collaborative workspace. More specifically, the collaborative workspace folder view may display the electronic mail message in the context of other activity of that object type in the collaborative workspace.

According to another embodiment of the invention, the collaborative workspace module includes an access control module that enables an authorized user to control whether a particular folder is open to all participants in the collaborative workspace or at least partially restricted.

According to an embodiment of the invention, the collaborative workspace module may include means for enabling participants to annotate content stored in the project folder or a sub-folder. The collaborative workspace module may also include an annotation access control mechanism for enabling participants to control whether a particular annotation is open to all participants in the collaborative workspace or at least partially restricted. Annotations that are at least partially restricted are only replicated to participants permitted access to the annotations.

According to an embodiment of the invention, the collaborative workspace module may enable participants to create one or more personal sub-folders in the collaborative workspace folder. The collaborative workspace module may also include a sub-folder access control mechanism for enabling a participant to control whether a personal sub-folder is open to all participants in the collaborative workspace or at least partially restricted. Personal sub-folders that are at least partially restricted are only replicated to participants permitted access to the personal sub-folders.

According to an embodiment of the invention, the collaborative workspace may work with any number of various well-known computer system configurations. For example, according to one embodiment of the invention, the collaborative workspace may be stored on a client device, while in other embodiments it may be stored on a server. As such, the various system configurations disclosed herein should not be viewed as limiting.

According to another embodiment of the invention, the system may include a protocol that enables the replication of the collaborative workspace in the electronic mail application of any user that accepts the invitation, regardless of which platform the accepting user's electronic mail application is running. The collaborative workspace may include collaborative objects, and the collaborative objects may be transmitted, via electronic mail, to all users participating in the collaborative workspace. The collaborative objects may also be converted to an independent format and viewed in a user's electronic mail application.

According to an embodiment of the invention, collaborative workspace objects may comprise at least one or more of message objects, event objects, task objects, file attributes objects, participant objects, or other objects. A message caused to be sent by the collaborative workspace module may adhere to MIME and S/MIME standards, and may include data about a given collaborative workspace object (e.g., project, folder, message, task, event, file, outline) and its attributes (e.g., name, creation date, author, etc.) in a platform independent format. The collaborative work space module may then convert the data into an XML format with a platform neutral schema with all encompassing attributes before transmitting to a recipient. Upon receipt, a recipient's collaborative work space module may convert the object to the platform's format reconciling differences in the naming and type of attributes.

According to another embodiment of the invention, a relay box for supporting POP3 and SMTP protocols for receiving and sending electronic mail is provided. The relay box may be hosted on a relay box server, which is a server other than a server hosting the mail application of a project participant. The relay box may be used when a participants own electronic mail server does not support POP3 access. A relay box is created and assigned as part of the user's registration prior to downloading the collaborative workspace module. The collaborative workspace protocol may include means for dealing with users who require a relay box for the transfer of collaborative work space messages. Because the collaborative workspace module protocol may rely on rich access to a user's mailbox (and uses XML-tagged messages), the relay box configuration may be utilized for users when rich access to the user's mailbox is not possible. Generally, the relay box configuration may be used for users when the user retrieves their electronic mail using the standard POP3 protocol. The relay box may include a local POP3 proxy that reads the electronic mail arriving at the user's inbox, and copies appropriate messages into the relay box's own data store for rich processing.

According to an embodiment of the invention, the collaborative work space includes collaborative objects that may comprise structured items. The structured items may comprise structured item data, and the collaborative workspace protocol supports changing the structured item data by sending XML-tagged electronic mail messages to other participants to update their local copy of the shared space with the changed data.

When the collaborative work space module resides on a server, the module may monitor a designated number of mailboxes. When a collaborative workspace message arrives at a mailbox, the module transfers it to a centralized collaborative workspace storage. If the same collaborative workspace message arrives at different user mailboxes on the same server, the module may only process one of the messages and ignore other copies of the message.

According to one embodiment of the invention, a designated project leader of a collaborative work space may invite and add new users. Other users may propose new members to the project leader. A proposed new member message is sent as an XML-tagged electronic mail to the project leader, who can decide whether to invite the new member or not.

According to an embodiment of the invention, a user may simultaneously view a message in an inbox view and in the context of the collaborative workspace to which it belongs in a project view. In addition, a user may reply to the message from the inbox without having to separately access the project view, and the reply message may automatically be placed in the context of the collaborative workspace.

According to one embodiment of the invention, electronic mail users without the collaborative workspace module can participate in a collaborative workspace as an electronic mail only participant. An electronic mail only participant may be enabled by replying to a collaborative workspace invitation without downloading the collaborative workspace module. An electronic mail only participant may later become a full participant by installing the collaborative workspace module. Electronic mail only participants may receive changes/additions to a collaborative workspace via electronic mail messages. Electronic mail only participants may receive changes/additions to a collaborative workspace optionally formatted in HTML with contextual information.

When a new message is added to a discussion, electronic mail only participants are sent a message containing the subject and contents of the message, and the applicable list of messages in the discussion in which the message was created. When a new task is added to a task list, electronic mail only participants are sent a message containing the task and the applicable task list related information. When a new calendar item is added to a calendar, electronic mail only participants are sent a message containing the calendar item and applicable calendar related information. When a new file is added to a file list, electronic mail only participants are sent a message containing the file and the applicable file list related information.

According to an embodiment of the invention, electronic mail only participants may receive at their option a daily/weekly summary of what is new in a collaborative workspace. Electronic mail only participants may respond to a message and the response may be placed in the collaborative workspace. In the participants view, electronic mail only participants may appear in the view with a graphical designator showing that they are electronic mail only participants.

Many additional features and functions may be incorporated into the invention. For example, a polls/voting feature may provide participants with the ability to create a “question/survey” form that is distributed to all of the other participants. Each participant then may vote (given the available options as provided by the poll creator) and the votes may be tallied and summarized.

According to one embodiment of the invention, a notification feature may also be provided to keep participants apprised of activity in a project folder or in specific folders within the project. Users may, for example, subscribe to daily or weekly summaries for project or folder activity. A project leader may designate a particular server, as described in greater detail below, or participant to generate these summaries for each subscribing participant. Summaries may be valuable for enabling moderately-involved participants to stay abreast of project activity without analyzing all of the project activity.

According to one embodiment of the invention, an outliner feature may be incorporated into the invention. The outliner feature may allow for the creation of documents in an outline format (e.g., Ecco, NoteMap, Word). The invention may, for example, enable an outliner folder to be added to a project folder.

According to one embodiment of the invention, the invention may also include a mechanism for dealing with “incomplete” or “hollow” system objects (e.g., a file). An object may be deemed incomplete or hollow because only header information may be available (e.g., title, author, date) and not the contents. Hollow objects may be used in situations where the contents of a message are large enough (e.g., a large video file) to require/desire for a separate and/or optional retrieval of the object contents. Accordingly, the invention may incorporate mechanisms for displaying hollow documents in the user interface, allowing the user to manually request the retrieval of the object's contents, and/or scheduling the automatic retrieval of object contents According to one embodiment of the invention, various synchronization and data security features, and protocols, are provided to ensure that the integrity of the collaborative workspace is maintained for all participants associated with a project, regardless of their platform.

According to one embodiment of the invention, a synchronization method for fully or partially synchronizing new project participants is provided. An on-going monitoring may occur to identify when one or more participants are in an “out-of-sync” state with regard to a collaborative workspace.

According to one embodiment of the invention, at least three types of synchronization schemes may be used for data synchronization. These include listener synchronization, talker synchronization, a hybrid synchronization, as well as other synchronization techniques.

According to an embodiment of the invention, participants may be afforded varying levels of access to project folders or subfolders. Access Control Lists (ACLs) may, for example, be used to enforce access levels for participants to read, write, author, or update messages, or to control other access.

According to one embodiment of the invention, functionality may be incorporated into the invention to synchronize a collaborative project space when project states are not necessarily uniform across all participants due to varying access levels among participants. Also, an auto-updating feature may be incorporated for participants whose access level has been changed. The invention may also, in various embodiments, incorporate synchronization capability to handle electronic mail messages that may not be delivered due to delivery failures.

According to one embodiment of the invention, the system may comprise one or more designated Universal Clock Servers (or other tools) to obtain reliable timestamps on project messages and/or transactions, and to account for discrepancies that may exist among the individual system clocks of participants in a project.

According to one embodiment of the invention, security measures may be implemented to ensure that the confidentiality and integrity of transmitted project messages are maintained. Additional security functionality may be provided to enable the authentication of project commands/messages. In the system, all project participants may be issued certificates such that all messages that have been authored by a participant will be digitally signed with the system-generated certificate. The system may also generate public/private and symmetric keys on a project-by-project basis.

According to one embodiment of the invention, a method may be provided for generating and managing secure communications over open protocols.

Some or all project messages may also, according to an embodiment, use an enveloped technique, whereby the message content is encrypted with a one-time symmetric key, as per the S/MIME specification.

According to one embodiment of the invention, a method may be provided for embedding receipt acknowledgement within outgoing messaging. Upon receiving a message from another participant, and rather than sending a confirmation message when the message has been received and/or opened, a method may be employed that embeds the receipt acknowledgement within a naturally occurring (i.e. user driven) email message.

Another aspect of the invention relates to a system and method for leveraging the existing messaging infrastructure, including protocols and servers, to replicate a collaborative space from an electronic mail environment in one computer to another electronic mail environment in another computer. Another aspect involves using the existing messaging infrastructure of an electronic mail system for project management functionality including the ability to send project management messages comprising project data and commands.

The system appends a proprietary S/MIME part to outgoing messages, the part comprising information to: represent the contents of the message in a format independent of electronic mail platform; identify the collaborative workspace to which the message relates; securely identify the originator of the message; and securely encrypt the contents of the message.

The S/MIME part is formatted in XML format independent of electronic mail platform. A receiving end decrypts the message, reads the S/MIME part, re-formats the message to match the receiver's electronic mail platform which may be different than the sender's electronic mail platform, and places the message in the intended collaborative workspace folder.

The system includes a collaboration protocol comprising commands and arguments, embedded in electronic mail messages as an S/MIME part for the purpose of maintaining two or more collaborative spaces synchronized. The collaboration protocol for enables inviting and “bootstrapping” new participants to an electronic mail-based collaborative work space.

These and other objects, features, and advantages of the invention will be apparent through the detailed description of the preferred embodiments and the drawings attached hereto. It is also to be understood that both the foregoing general description and the following detailed description are exemplary and not restrictive of the scope of the invention.

### BRIEF DESCRIPTION OF THE FIGURES

FIG. 1 is an illustration of a projects folder according to one embodiment of the invention.

FIG. 2 is an illustration of a project creation display according to one embodiment of the invention.

FIG. 3 is an illustration of a projects folder according to one embodiment of the invention.

FIGS. 4A and 4B are illustrations of a project calendar folder according to one embodiment of the invention.

FIG. 5 is an illustration of a project files folder according to one embodiment of the invention.

FIG. 6 is an illustration of a project participants folders according to one embodiment of the invention.

FIG. 7 is an illustration of a project participants folders according to one embodiment of the invention.

FIG. 8 is an illustration of a project tasks folder according to one embodiment of the invention.

FIG. 9 is an illustration of a project files folder according to one embodiment of the invention.

FIG. 10 is an illustration of an electronic mail application inbox according to one embodiment of the invention.

FIG. 11 is an illustration of a project folder according to one embodiment of the invention.

FIG. 12 is an illustration of a project participants folder according to one embodiment of the invention.

FIG. 13 is an illustration of a project tasks folder according to one embodiment of the invention.

FIG. 14 is an illustration of a project calendar folder according to one embodiment of the invention.

FIG. 15 is an illustration of a projects folder according to one embodiment of the invention.

FIG. 16 is an illustration of a project invitation electronic mail message according to one embodiment of the invention.

FIG. 17 is an illustration of a project participants folder according to one embodiment of the invention.

FIG. 18 is an illustration of a project participants folder according to one embodiment of the invention.

FIG. 19 is an illustration of an electronic mail application inbox according to one embodiment of the invention.

FIG. 20 is an illustration of a project invitation electronic mail message according to one embodiment of the invention.

FIG. 21 is an illustration of a project folder according to one embodiment of the invention.

FIG. 22 is an illustration of a standard inbox and project folder inbox according to one embodiment of the invention.

FIG. 23 is an illustration of a standard inbox and project calendar folder according to one embodiment of the invention.

FIG. 24 is an illustration of a project electronic mail message with an attached file according to one embodiment of the invention.

FIG. 25 is an illustration of a project files folder according to one embodiment of the invention.

FIG. 26 is an illustration of a project files folder according to one embodiment of the invention.

FIG. 27 is an illustration of a user-defined project folder according to one embodiment of the invention.

FIG. 28 is an illustration of a user-defined project folder according to one embodiment of the invention.

FIG. 29 is a schematic block diagram of a client-side system f or providing an electronic mail application with integrated collaborative space management according to one embodiment of the invention.

FIG. 30 is a schematic block diagram of a server-side system for providing an electronic mail application with integrated collaborative space management according to one embodiment of the invention.

FIG. 31 is a schematic block diagram of a system for providing an electronic mail application with integrated collaborative space management according to one embodiment of the invention.

FIG. 32 illustrates a flowchart of processing according to the invention, in one regard.

FIG. 33 is a schematic diagram illustrating a synchronization process for synchronizing new collaborative workspace participants.

FIG. 34 is a schematic diagram illustrating a method for identifying users that may be out of synch with a collaborative workspace.

FIG. 35 is a schematic diagram illustrating a method for identifying users that may be out of synch with a collaborative workspace.

FIG. 36 is a schematic diagram illustrating a process for obtaining reliable timestamps on collaborative workspace transactions.

### DETAILED DESCRIPTION OF THE INVENTION

According to one embodiment, the invention is a system that provides a collaborative electronic mail application and infrastructure that allows users to create projects where messages, files, calendar events, tasks, and other user-defined content and workflow processes may be securely shared with other project participants regardless of a user's system platform or location. The invention provides a virtual collaborative space by fully leveraging an existing messaging infrastructure, allowing organizations to collaborate with each other regardless of application or platform, transparently incorporating standard public key infrastructure to authenticate users and encrypt messages, and richly integrating with the user's electronic mail environment to not require switching from email to collaboration.

According to one embodiment of the invention, a user may install the system on a client device or a server. Preferably, after installation initiation by the user, the system installs and configures itself automatically to function with the client device or server platform. The system may request information from the user, for example, a location where the user desires the system to be saved, during installation. The system may generate a standard security certificate for the user containing a public and a private key. Once installed and operational, the system may indicate that a projects folder has been added to the user's mailbox and is ready for a new team project to be created.

The system may provide a graphical user interface that is completely integrated and fully consistent with a client or server platform, for example, Microsoft Outlook™, Lotus Notes™ or other platform.

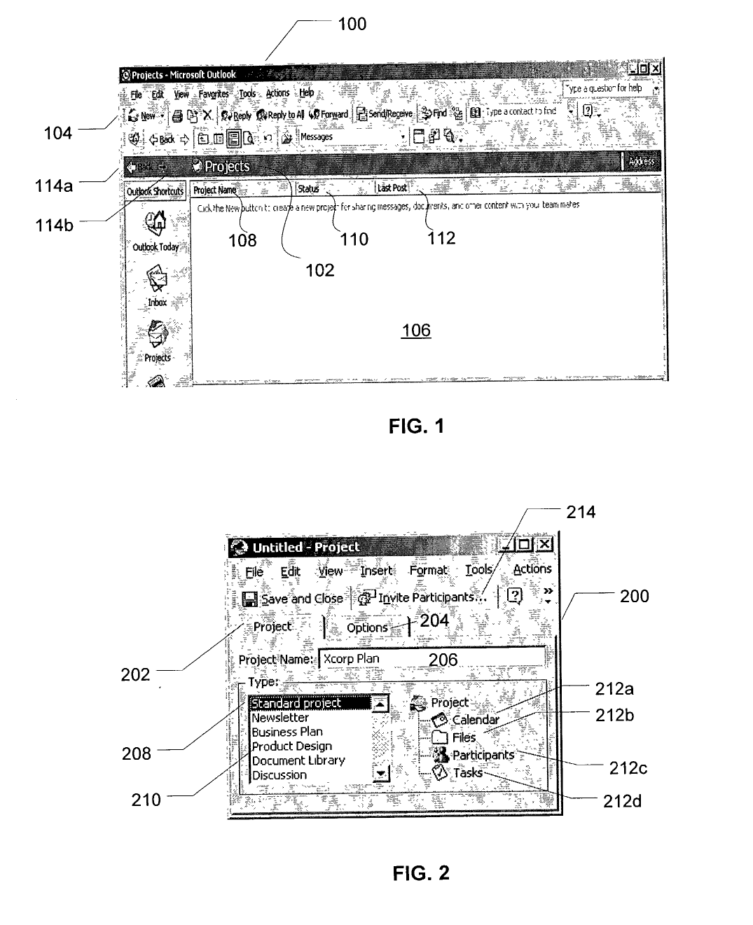

FIG. 1 is an illustration of a display 100 that may be presented to a user that operates on a Microsoft Outlook™ platform, according to one embodiment of the invention. The system may create a Projects folder 102 within the user's mailbox. If the user selects the Projects folder, particular functionality related to projects may be applied to standard tools provided with Microsoft Outlook™. For example, a New button 104 may be used to create a new project within the Projects folder. A portion 106 of a Projects folder display 100 may provide selectable information portions regarding a project such as, for example, project name selectable information portion 108, status selectable information portion 110, and last post selectable information portion 112. Additional tools may also be provided such as, for example, navigation buttons 114a-114b that enable a user to navigate among a plurality of projects.

If a user desires to create a new project, the user may select New button 104. A project creation display 200 may be displayed as shown in FIG. 2. Display 200 may include a project tab 202 and an options tab 204. Project tab 202 may be a default tab that is initially presented to the user. Project tab 202 may include a project name input box 206. Project name input box 206 may enable a user to input a name for a new project. For example, the user may desire to create a project titled “Xcorp Plan.” The user may then input Xcorp Plan into project name input box 206.

Project tab 202 may also include a type portion 208 that may be used to assign a type to a new project. A list of types 210 may be displayed in type portion 208. The list of types may include, for example, standard project, newsletter, business plan, product design, document library, discussion, and other types. Type portion 208 may also display subfolders 212a-212d that may be associated with a project. The subfolders may include, for example, calendar 212a, files 212b, participants 212c, and tasks 212d. Other folders may also be created.

Project creation display 200 may also include an invite participants selectable portion 214. Invite participants selectable portion 214 may enable a user to invite other users to participate in a project. This is described in more detail below. Options tab 204 may provide a plurality of variable options that the user may select regarding the project such as, for example, maximum number of participants, roles of participants, etc.

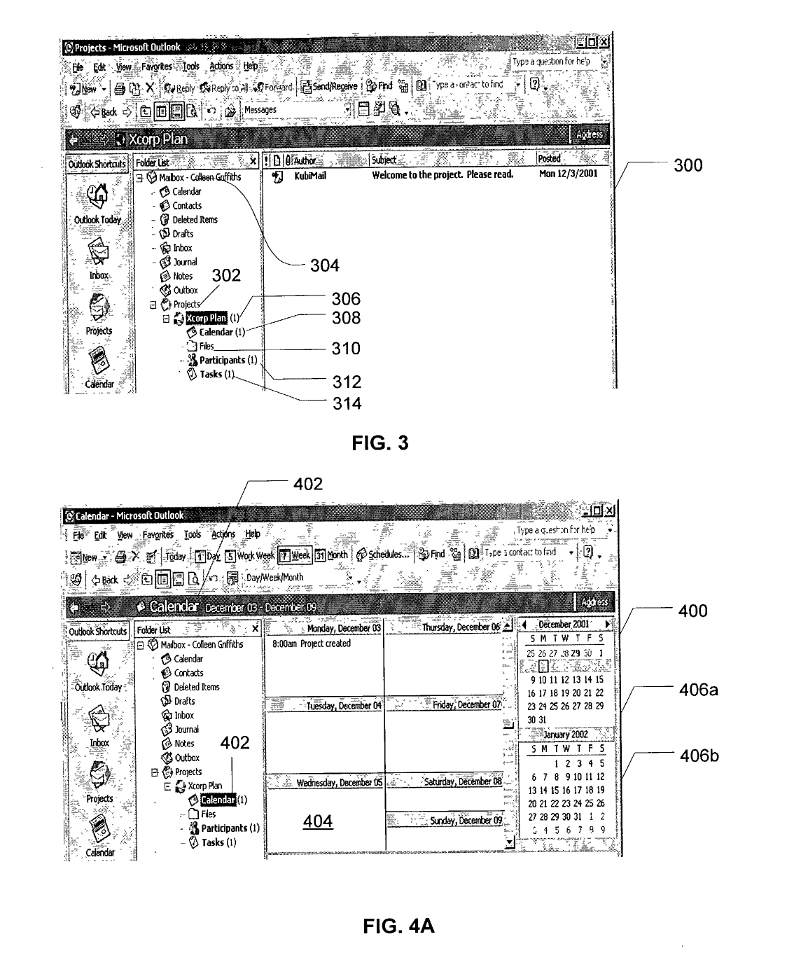

FIG. 3 is an illustration of a display 300 of a projects folder 302 for a project titled Xcorp Plan. The project “Xcorp Plan” is created as a folder in the user's mailbox 304. The folder may include a main project folder 306, calendar 308, files 310, participants 312, and tasks 314. As shown, alone one user is a participant in the project. The user, however, may invite other users to participate in the project and if so, a Projects folder for that project may appear in that user's mailbox.

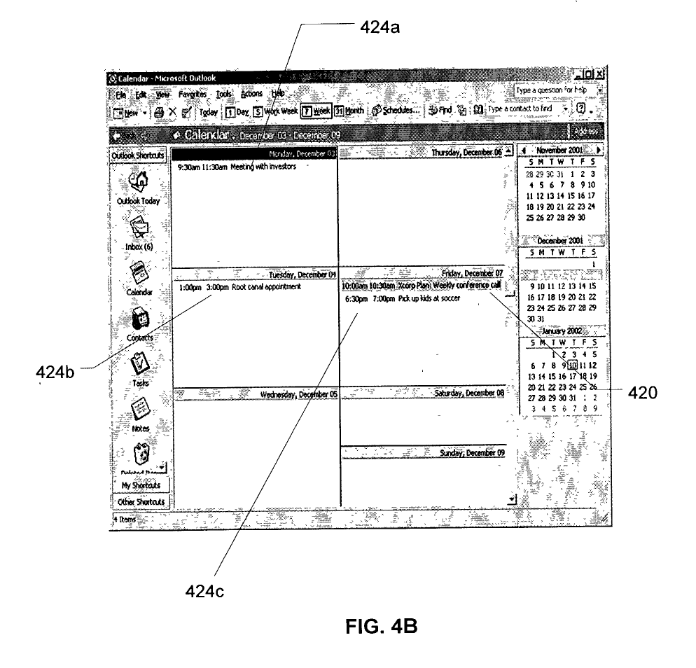

FIG. 4A is an illustration of a display 400 of a project calendar folder 402 according to one embodiment of the invention. A portion 404 of display 400 may be used to present a user with calendar events relating to the project. The calendar events may be displayed in portion 404 in any known manner. For example, the calendar events may be displayed in a daily, weekly, monthly or yearly manner. Display 400 may also include a display of calendar months 406a-406b. Any number of months, however, may be displayed. Portion 404 may identify a calendar event, for example, project created, associated with a project and may also identify a time at which the event occurred. Other information may also be displayed. Other standard calendar functionality, for example, creating a new calendar event, may also be provided.

As illustrated in FIG. 4B, a project-related calendar event 420 may be implicitly integrated with a user's personal information manager (e.g., Lotus Notes™ and Microsoft Outlook™) such that the projected-related calendar event 420 appears along with non-project-related calendar events, such as events 424a, 424b, and 424c.

According to one embodiment of the invention, project-related calendar events (e.g., event 420) may be distinguished from non-project-related calendar events in the display by altering the appearance of the project-related calendar events. For example, as shown in FIG. 4B, project-related calendar event 420 is shaded, while non-project-related calendar events 424a, 424b, and 424c are not. Project-related calendar events may also be distinguished via any number of various color shades, font sizes, styles, or colors.

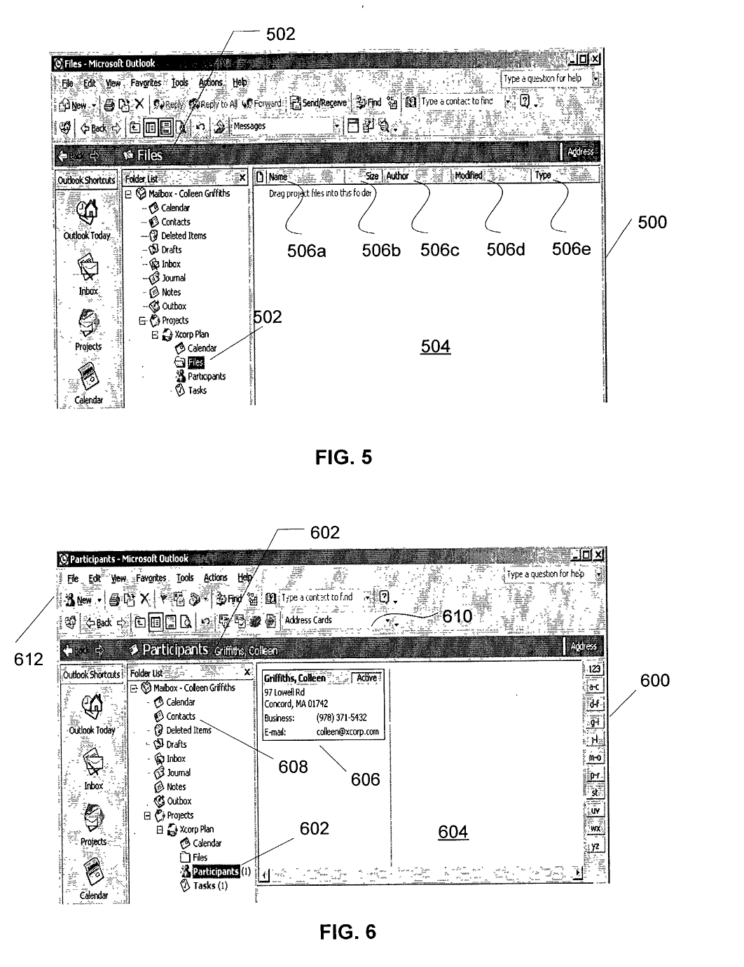

FIG. 5 illustrates a display 500 of a Files folder 502 according to one embodiment of the invention. Display 500 may include a portion 504 that lists a plurality of files associated with the project. Files folder 502 may include selectable information portions 506a-506e that provide information regarding files associated with a project. For example, selectable information portions 506a-506e may include name 506a, size 506b, author 506c, modified 506d, type 506e or other file information. A user may arrange a file list according to file information criteria. For example, a user may select size selectable information portion 506b to list the files according to an ascending or descending order of file size. Other arrangements may also be selected.

FIG. 6 illustrates a display 600 of a Participants folder 602 according to one embodiment of the invention. Display 600 may include a portion 604 that presents contact information 606 as address cards for users that are participants in a project. The contact information may be retrieved from, for example, a Contacts folder 608 provided by the user's personal information manager (e.g., Microsoft Outlook™, Lotus Notes™). The way in which information is presented in portion 604 may be varied using view selector 610. View selector 610 may be, for example, a pull-down menu that provides the user with a plurality of options for displaying information regarding project participants. For example, view selector 610 may provide the user with name, address cards, detailed address cards, phone list or other user-defined view preference. Information presented in portion 604 may then be displayed according to the option selected. Other standard participant functionality, for example, adding a new participant by selecting New button 612, may also be provided.

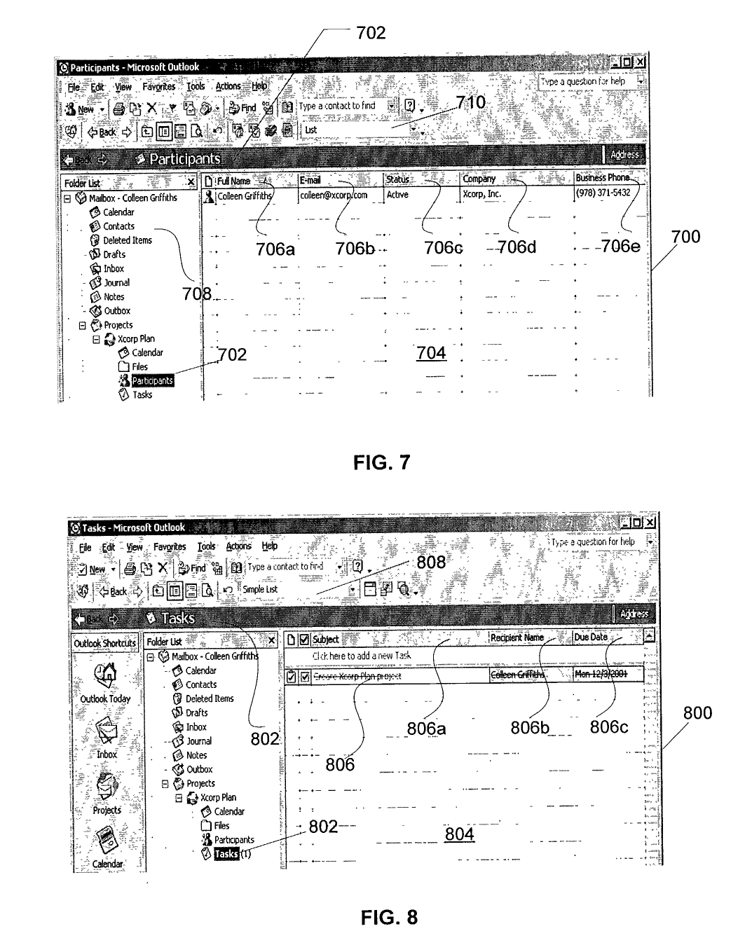

FIG. 7 illustrates a display 700 of a Participants folder 702 according to one embodiment of the invention. Display 700 may include a portion 704 that presents contact information as a list for users that are participants in a project. The contact information may be presented as selectable information portions 706a-706e. The selectable information portions 706a-706e may include full name 706a, e-mail 706b, status 706c, company 706d, and business phone 706e. Other types of contact information may also be presented. The contact information may be retrieved from, for example, a Contacts folder 708 provided by the user's personal information manager (e.g., Microsoft Outlook™, Lotus Notes™). The way in which information is presented in portion 704 may be varied using view selector 710. View selector 710 may be, for example, a pulldown menu that provides the user with a plurality of options for displaying information regarding project participants. For example, view selector 710 may provide the user with name, address cards, detailed address cards, phone list or other user-defined view preference. Information presented in portion 704 may then be displayed according to the option selected.

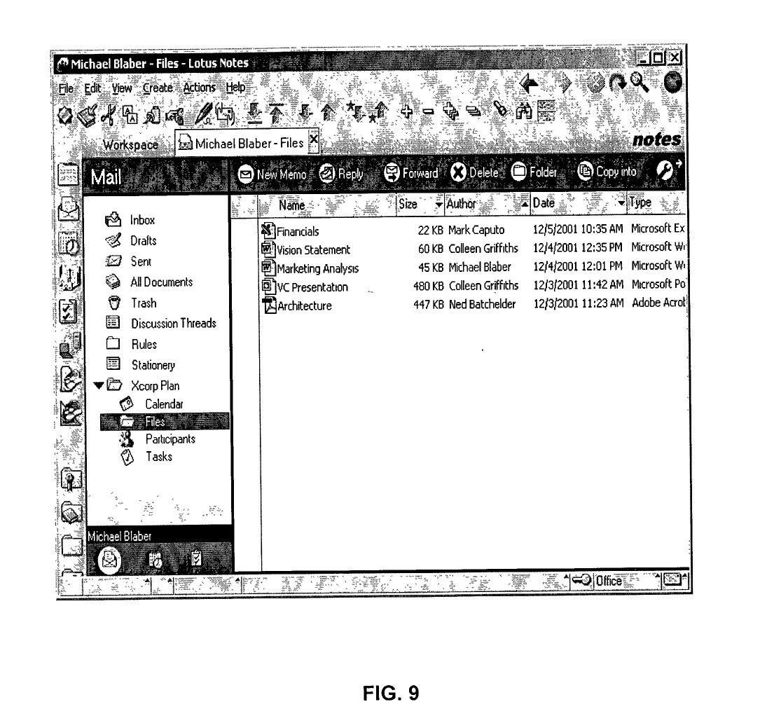

FIG. 8 illustrates a display 800 of a Tasks folder 802 according to one embodiment of the invention. Display 800 may include a portion 804 that presents tasks associated with a project. The tasks 806 may be presented as selectable information portions 806a-806c. The selectable information portions 806a-806c may include subject 806a, recipient name 806b, and due date 806c. Other types of task information may also be presented. The functionality for creating and maintaining tasks may be provided by the user's personal information manager (e.g., Microsoft Outlook™, Lotus Notes™). The way in which information is presented in portion 804 may be varied using view selector 808. View selector 808 may be, for example, a pull-down menu that provides the user with a plurality of options for displaying information regarding project participants. For example, view selector 808 may provide the user with a simple list, short, detailed list or other user-defined view preference. Information presented in portion 804 may then be displayed according to the option selected.

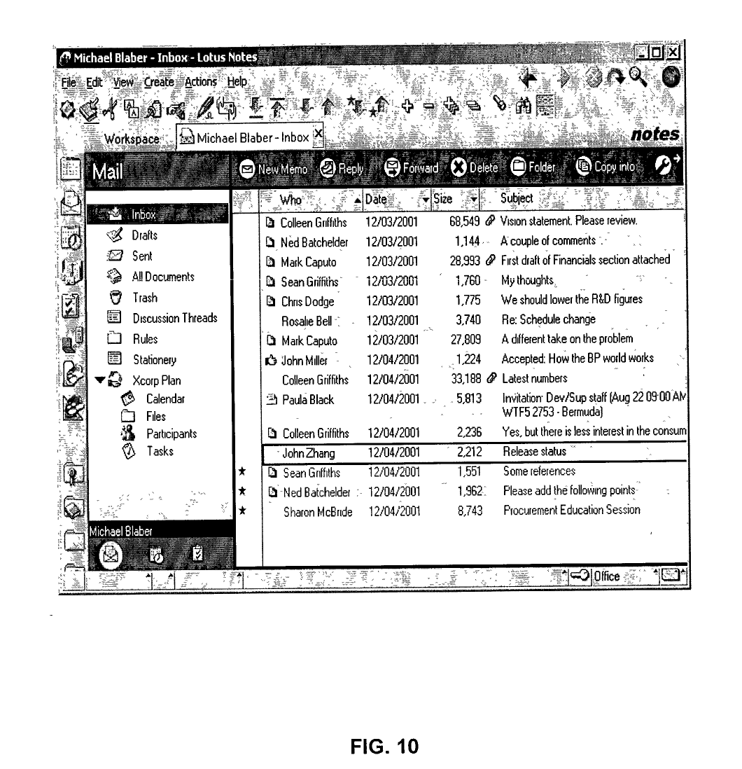

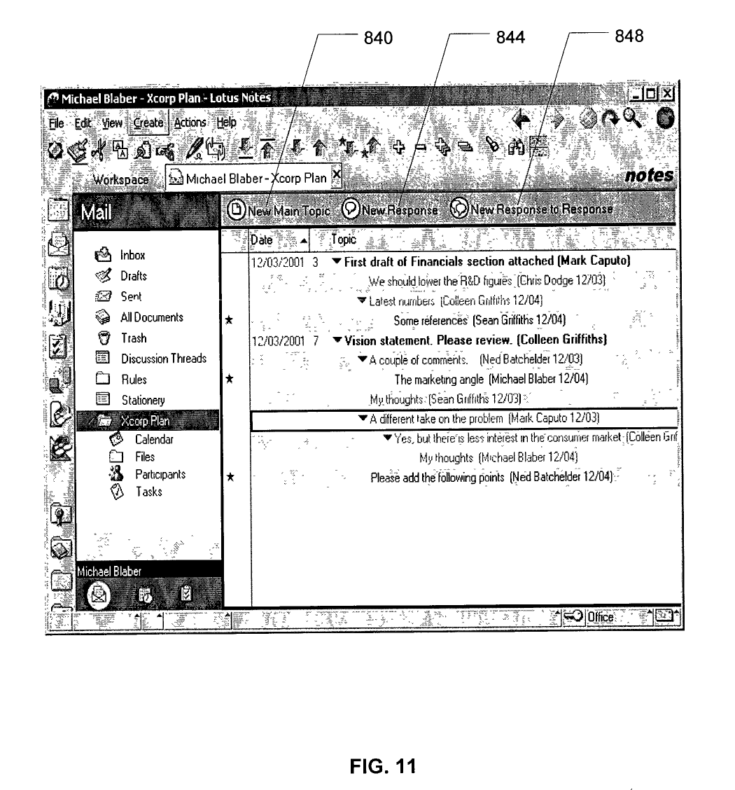

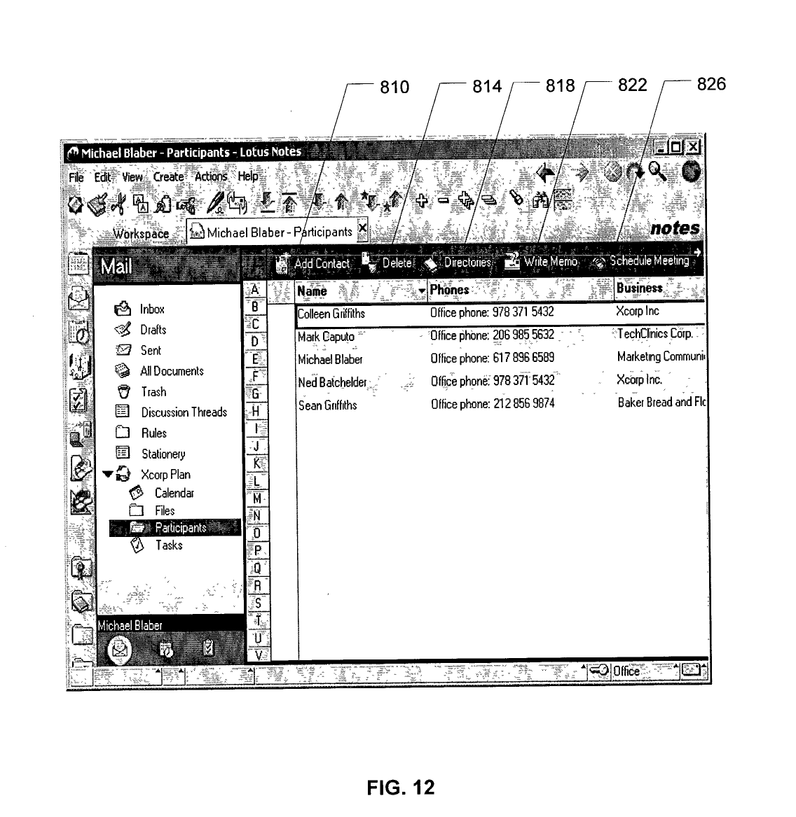

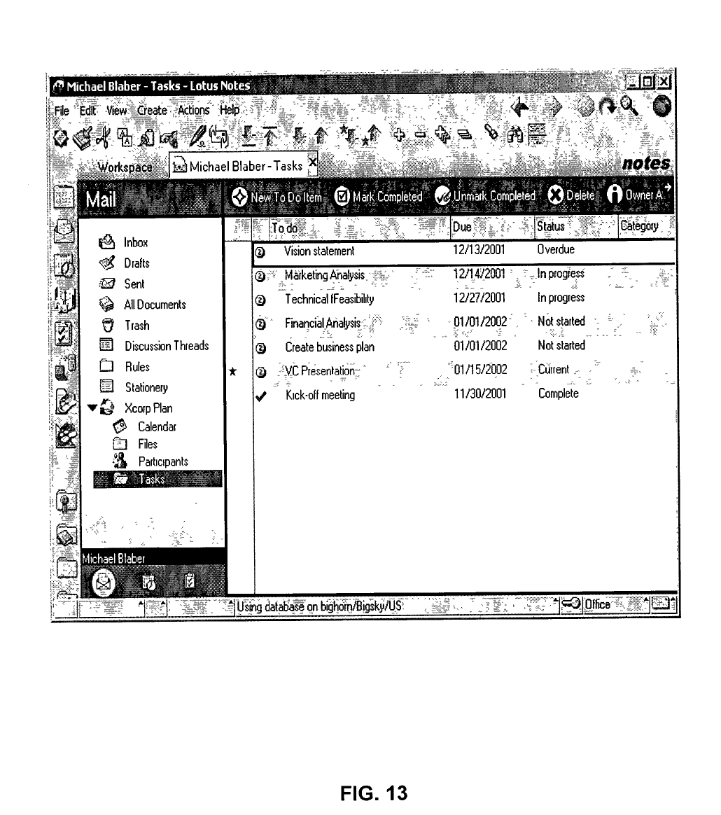

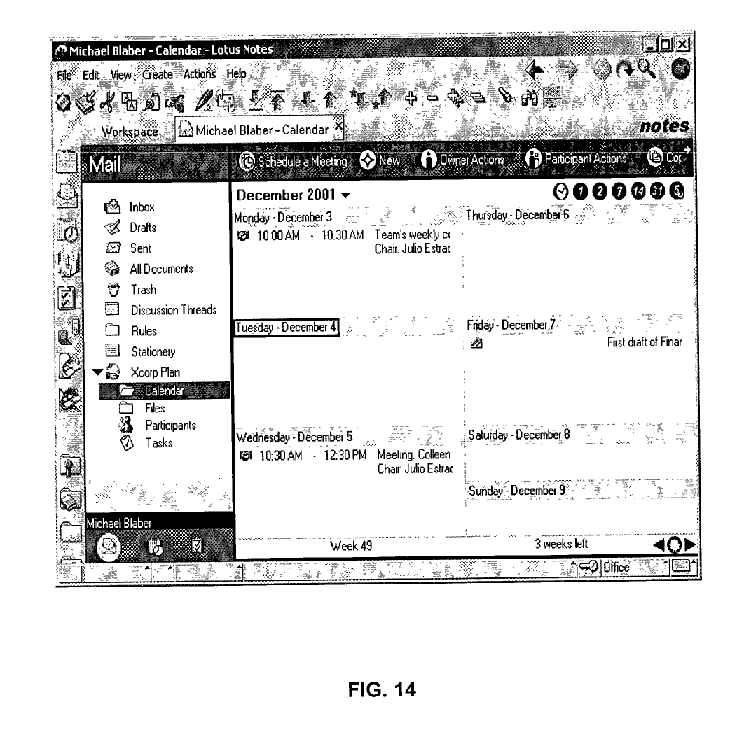

FIGS. 9-14 illustrate displays that may be presented to a user when using the invention with a Lotus Notes™ platform. FIGS. 9-14 illustrate a project files folder, standard inbox, project folder, project participants folder, project tasks folder, and a projects calendar folder, respectively. As with a Microsoft Outlook™ platform described above, the invention may utilize all functionality provided by Lotus Notes™. For example, as shown in FIG. 12, the project participants folder may be provided with selectable options (e.g., options 810, 814, 818, 822, 826) that enable a user to add or delete a contact, retrieve a directory, write a memo, and schedule a meeting, respectively. Additionally, invention specific functionality may also be provided. For example, as shown in FIG. 11, a project folder may be provided with selectable options (e.g., options 840, 844, 848) that enable a user to create a new main topic, new response, or new response to response, respectively.

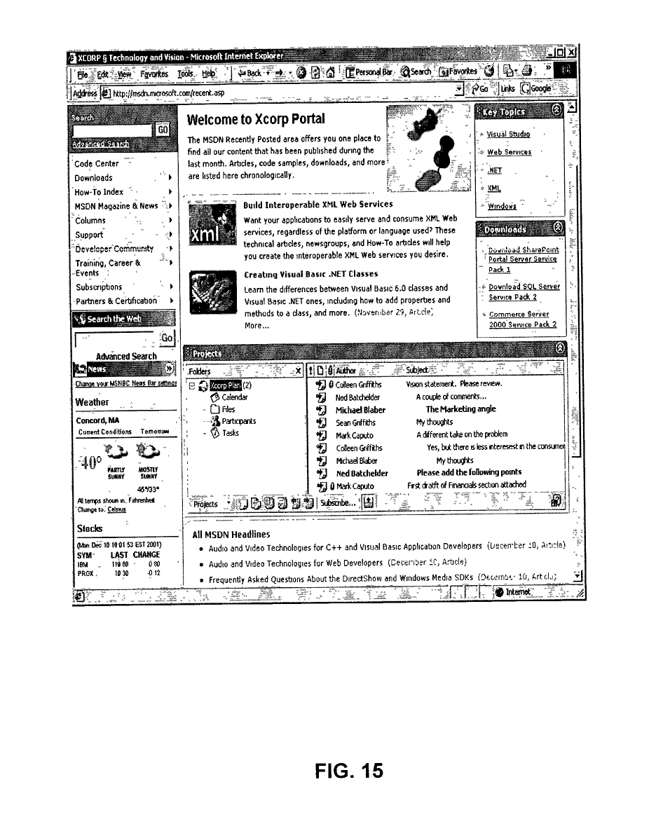

In addition to running on a Microsoft Outlook™ platform (as seen in FIGS. 1-8), or on a Lotus Notes™ platform (as depicted in FIGS. 9-14), the invention may be integrated into a number of other applications. For example, as illustrated in FIG. 15, the invention may be integrated into a corporate portal—a web site or service that offers a broad array of resources and services, such as e-mail, forums, search engines, and on-line shopping malls.

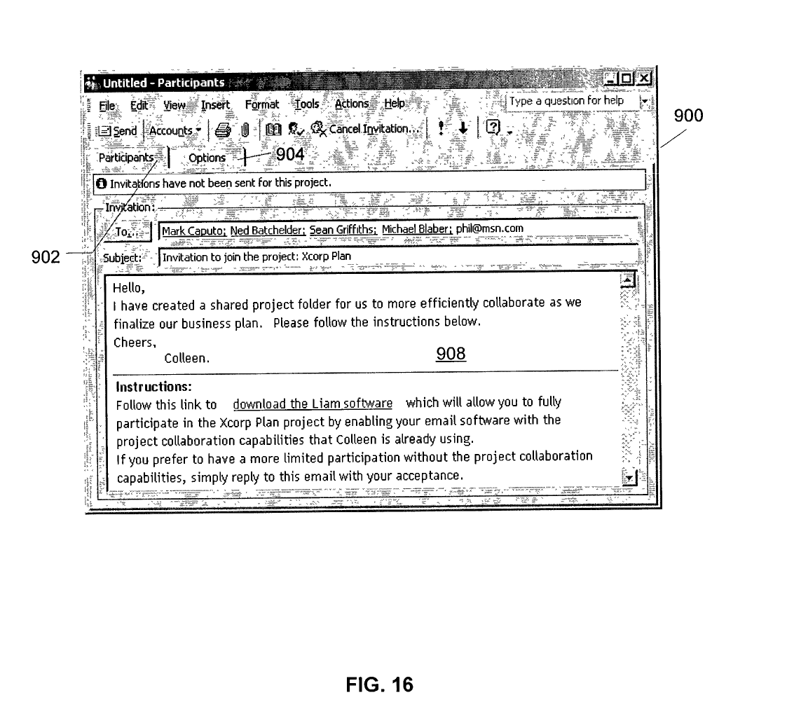

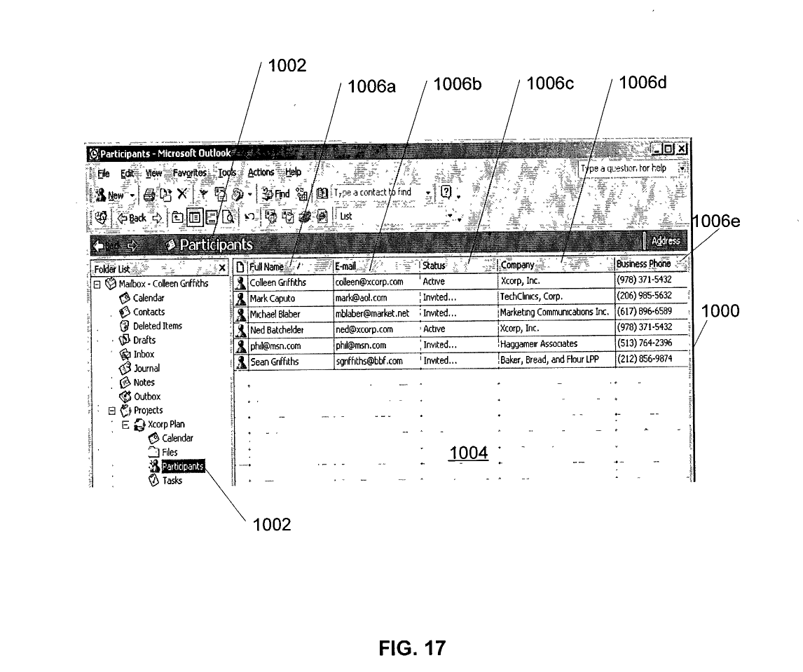

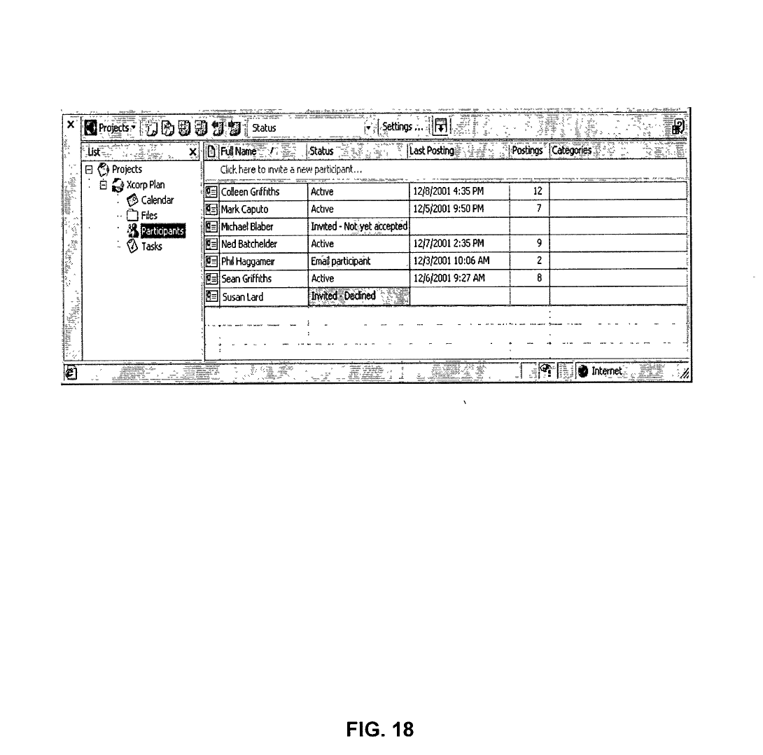

Having described various platforms capable of supporting the invention, as well as various folders that may be associated with a project, a manner for inviting other users to be participants in a project is now described. If a user desires to invite other users to be participants in a project, the user may use display 600, as shown in FIG. 6, to invite other users. The user may select New button 612 using, for example, a conventional computer mouse or keyboard, voice recognition software, light pen, touch-screen or other input mechanism, to invite a new user to be a participant in the project. By selecting New button 612, the user may be presented with a standard electronic mail message display 900 as shown in FIG. 16.

Electronic mail message 900 may include a participants tab 902 and an options tab 904. Participants tab 902 may include a To field 906 that enables a user to input one or more user names to invite as participants to a project. According to one embodiment of the invention, to reduce the possibility of conflicts, a designated project leader may be the only individual allowed to invite (and then add) new users. However, users that may wish to propose new members for the project may have the ability to propose new members to the project leader. These proposals may be sent, for example, as xml-tagged electronic mail messages to the project leader, who may then decide whether to invite the proposed members or not. Of course, in alternate embodiments, any user may be able to invite and add new users.

Standard electronic mail functionality regarding electronic mail message composition such as directory look-up and a subject field may also be provided. A message body portion 908 may be presented to the user to enable the user to input text, links or other information into the electronic mail message. The message may be provided with information that enables the users to install software that enables the system of the invention to operate (if the user does not already have the software installed) or may add the project to the user's Projects folder if the user has the software installed and accepts the invitation.

After the user has sent the message, the user names provided in To field 906 may be added to the project's participants folder 1002 as shown in display 1000 of FIG. 17. A portion 1004 may list each user name that has been invited to be a participant in the project. The full name of each user may be associated with a full name selectable information portion 1006a, the electronic mail address for each user may be associated with e-mail selectable information portion 1006b, the status of each user may be associated with status selectable information portion 1006c, the company (if any) that a user is affiliated with may be associated with company selectable information portion 1006d, and a business phone number for each user may be associated with business phone selectable information portion 1006e. The status of each user may vary depending on the state of an invitation. For example, if an invitation has been sent to a user, but the user has not responded, the status may be Invited. If the user has accepted the invitation, the status may be listed as Active. If, however, the user has declined the invitation, the status may be Declined or Inactive. FIG. 18 illustrates an additional example of a view providing the status of invited project participants. According to one embodiment, different statuses (e.g., active, inactive, accepted, declined) may be expressed in a display using various color shades, font sizes, styles, or colors.

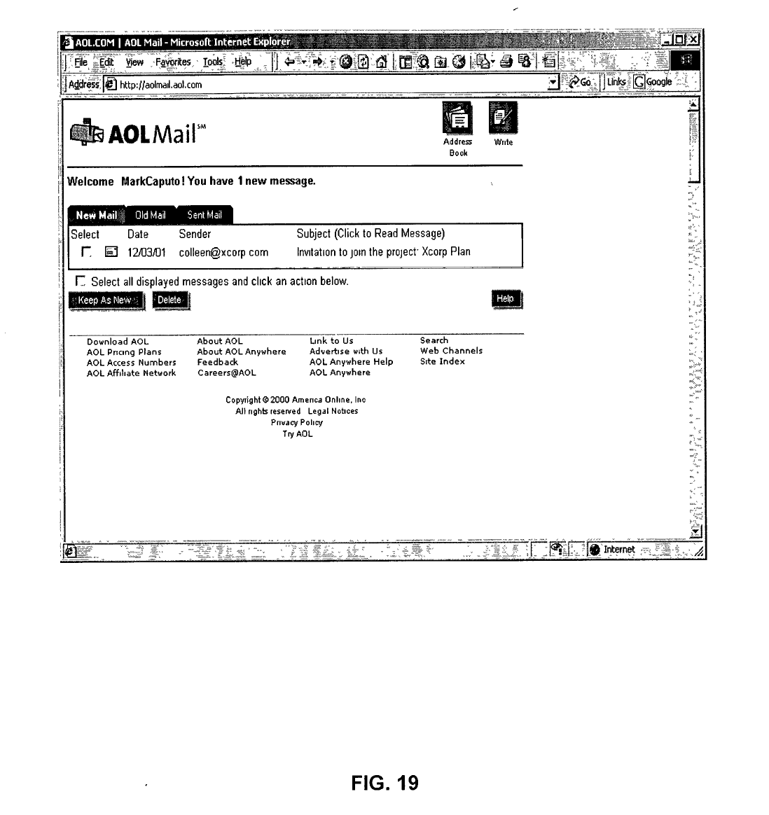

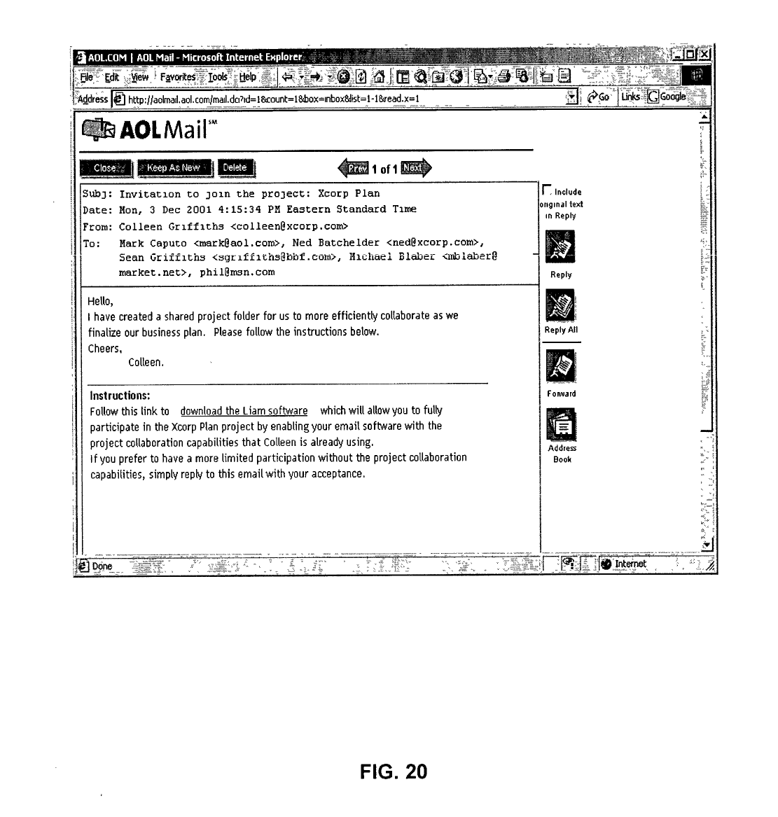

The message may arrive in the user's electronic mail application inbox of, for example, AOLMail^{SM} as shown in FIG. 19. The user may open the message and be presented with an electronic mail message as shown in FIG. 20. According to one embodiment of the invention, the user may be presented with Accept or Decline selectable options. If the user desires to decline the invitation, the user may select the decline option. An electronic mail message may then be transmitted to the sender of the invitation notifying the sender that the user has declined the invitation.

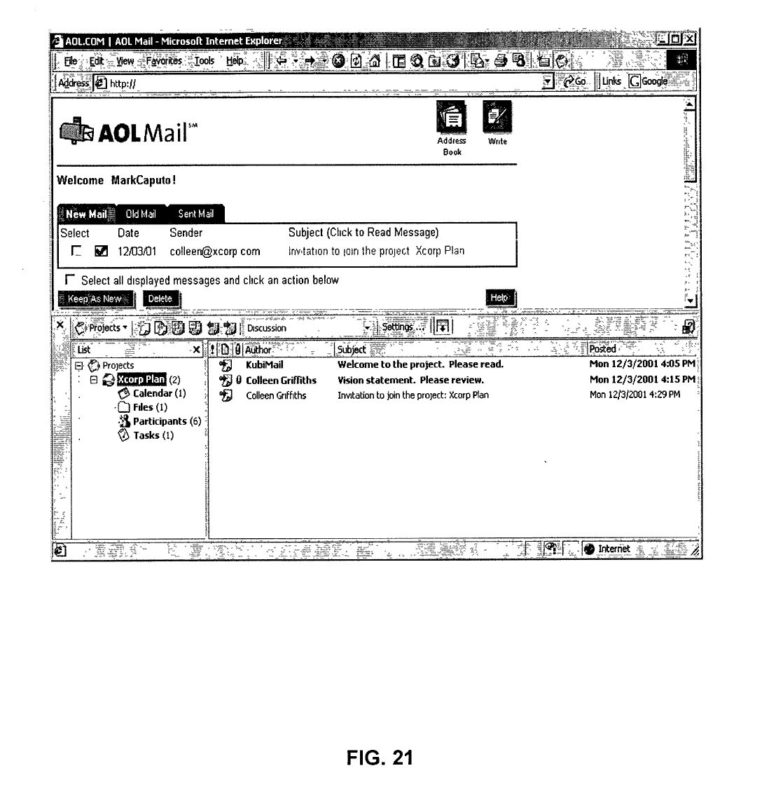

According to one embodiment of the invention, in addition to receiving the message in the standard inbox of the electronic mail application, the message is also automatically inserted into the project folder for the project with which the message is associated as shown in FIG. 21. The message that includes the invitation may have a subject reading, “Welcome to the project. Please read.” The message may appear as a standard message, however, the message is filed automatically into the folder for the project which the user is invited to participate. In the example shown, the message is filed in the Xcorp Plan project folder.

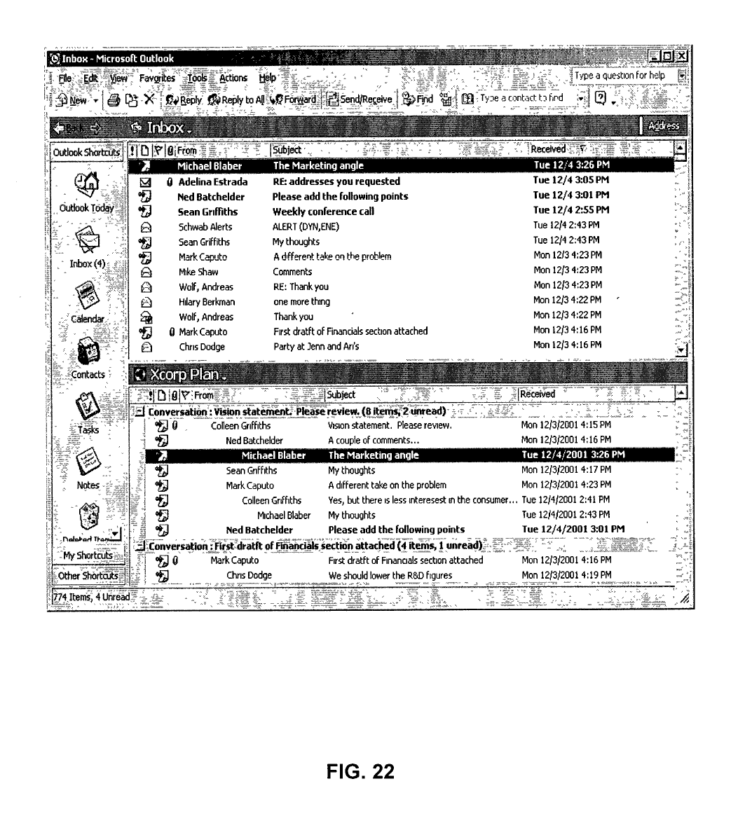

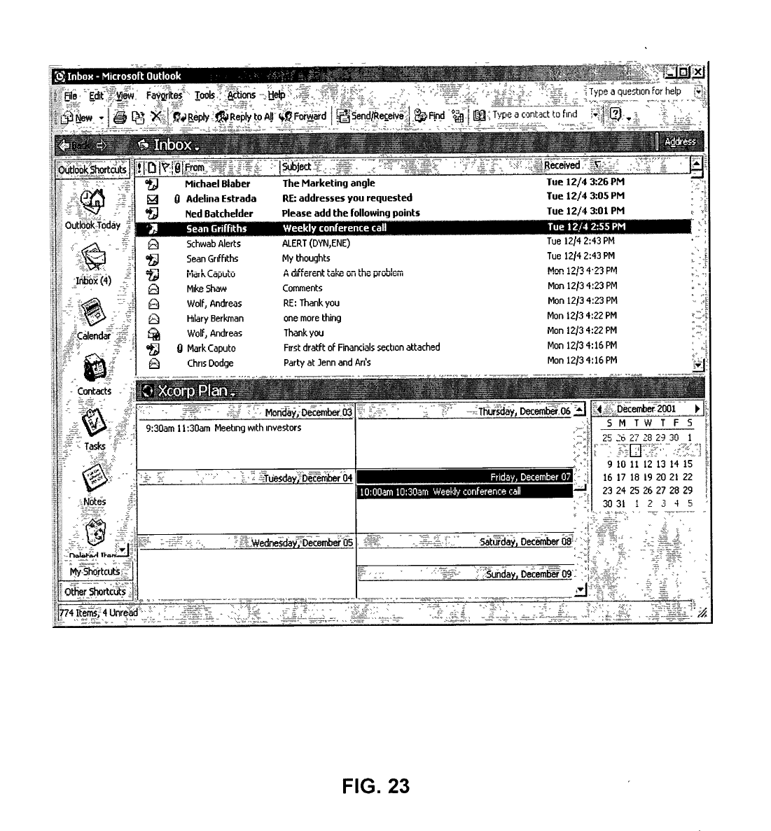

FIG. 22 illustrates an electronic mail message being received in a standard inbox and a project folder. FIG. 23 illustrates a calendar event being received in a standard inbox and calendar folder of a project folder.

When a new participant joins a project, he or she may need to initialize their copy of the project space (e.g., the project folder) with the current contents of the project work space. Projects may, of course, grow quite large, making this initialization process burdensome. To alleviate the burden, users may be presented with various options for initializing their project space with the current contents of the project work space.

A first option (not illustrated) may enable participants to get the most recent activity (n days worth), perhaps including older messages where needed to achieve the correct state. For example, parent topics older than n days may be copied if they have more recent replies.

A second option (not illustrated) may enable participants to receive the contents of certain folders, while a third option (not illustrated) may enable participants to receive the entire contents of the project work space. Additional options may be offered, including the ability to stagger the receipt of project information to regulate the flow of information. For example, a new participant may choose to receive all information, but no more than a particular volume per a designated time period (e.g., 3 megabytes per day). The contents of the project work space would then be sent to the new participant over as many days as required to meet the desired limit. It may be important to let the user control the initial project state because the project is stored in their inbox, and can grow large. Users' inboxes may be limited in size by their email provider (either corporate or commercial), and the user may find large downloads burdensome because of their connectivity.

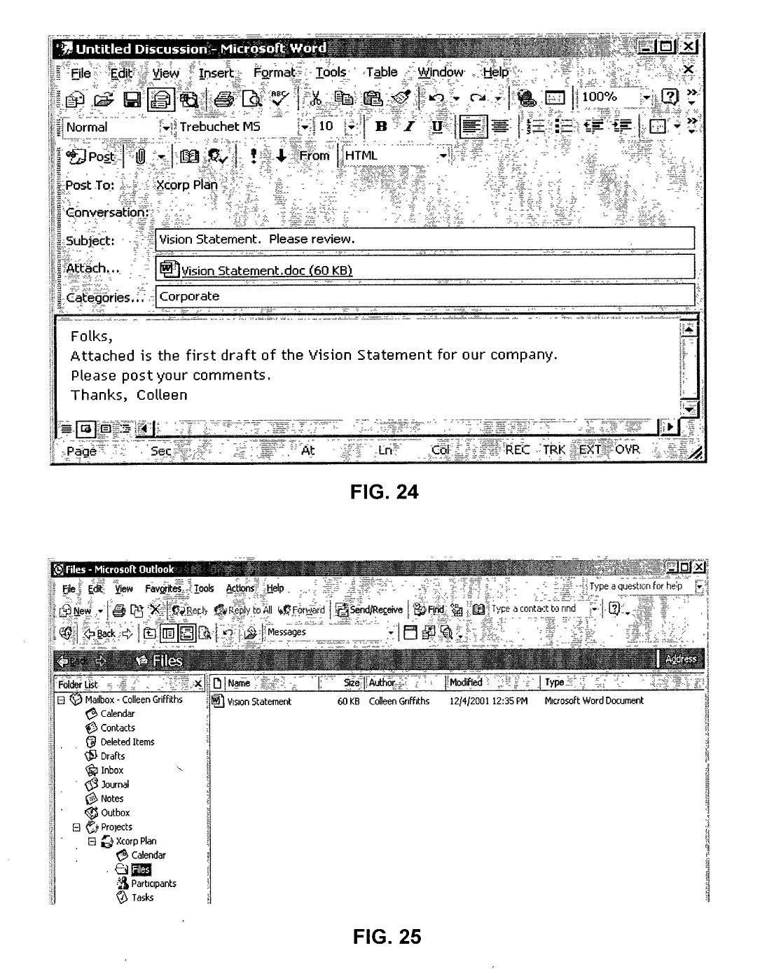

According to another embodiment of the invention, a user may create an electronic mail message with a file attached as shown in FIG. 24. This may be performed in any known manner. When a message relating to a project is received by a participant, however, the system may, in addition to receiving the message in a standard inbox and project folder, place the attached file into a files folder for the project as shown in FIG. 25.

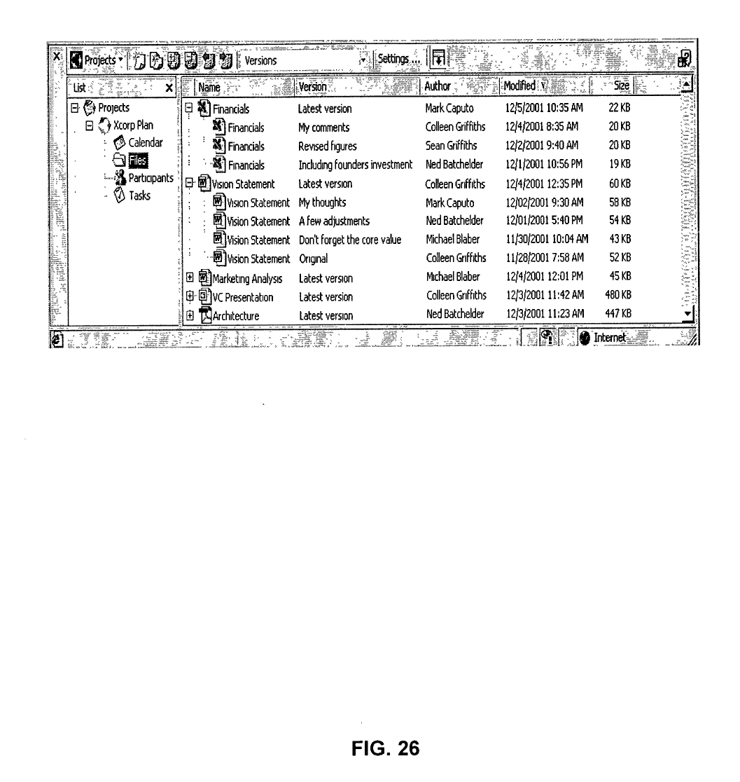

According to one embodiment of the invention, the files folder for a project may further comprise a file library. As shown in FIG. 26, the file library may include the latest or most recent version of each file, as well as older versions that may be retained for reference, review, comparison, or reversion. Because of the collaborative nature of the project folder, it may be important for participants to update files without fear of conflict among a number of revisions to the same file. Accordingly, each file may be assigned an internally generated I.D. that is unique within each project, with new versions of files being sent as attachments to xml-tagged electronic mail messages.

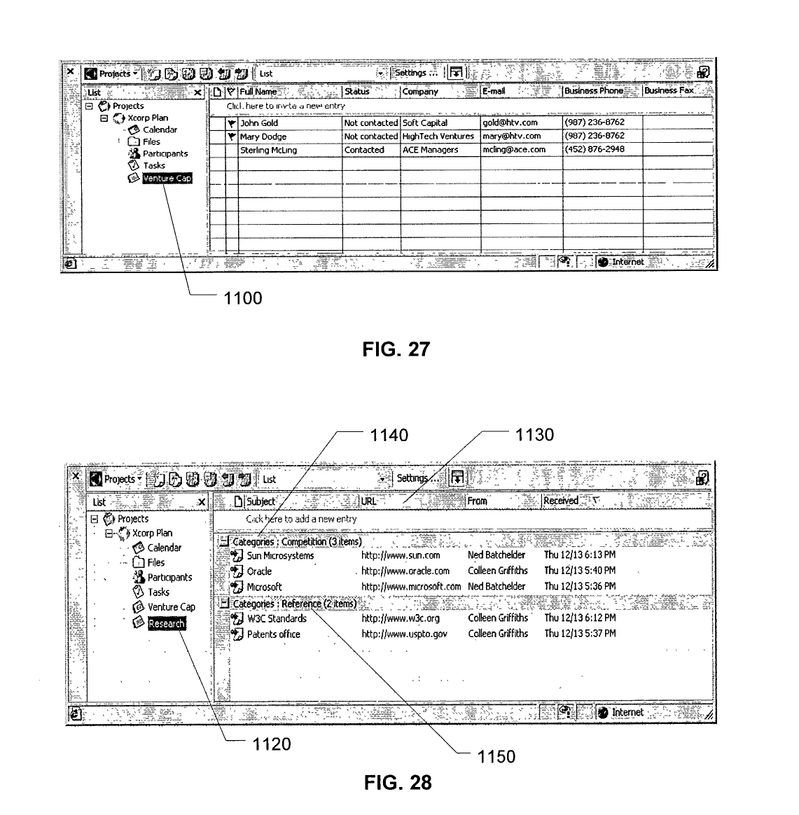

As illustrated in FIG. 27, participants may have the capability and functionality to create new, user-defined folders within the project folder, such as, for example, Venture Cap folder 1100. In addition, users may also have the ability to design their own schemas for data in a folder. For example, as depicted in FIG. 28, a user may create a Research folder 1120 having a customized URL field 1130. A user may also create various categories for data within the folder, such as, for instance, a Competition category 1140 or a Reference category 1150. Once a schema has been defined by a user, it may be communicated via xml-tagged electronic mail messages to other project participants using a similar e-mail client, or to participants across disparate e-mail clients.

In addition to the functionality disclosed above, various additional features may integrated within the invention. For example, a polls/voting feature may be incorporated into the invention. The polls/voting feature may provide participants with the ability to create a “question/survey” form that is distributed to all of the other participants. Each participant then may vote (given the available options as provided by the poll creator) and the votes may be tallied and summarized.

According to one embodiment of the invention, a notification feature may also be provided to keep participants apprised of activity in a project folder or in specific folders within the project. Users may, for example, subscribe to daily or weekly summaries for project or folder activity. A project leader may designate a particular server, as described in greater detail below, or participant to generate these summaries for each subscribing participant. Summaries may be valuable for enabling moderately-involved participants to stay abreast of project activity without analyzing all of the project activity.

According to one embodiment of the invention, an outliner feature may be incorporated into the invention. The outliner feature may allow for the creation of documents in an outline format (e.g., Ecco, NoteMap, Word). The invention may, for example, enable an outliner folder to be added to a project folder. The system of the invention may synchronize changes to an outline across some or all participants. To minimize possible conflicts between two or more participants making changes to the same outline, the system of the invention may treat each line in an outline as a separate record. Further, to allow a user to make many changes in a small time interval, the system may not send each change as it happens, but may rather buffer them and send them based on one of two conditions being met: a) a volume threshold being exceeded; or b) a time increment expiring. This “buffered update” feature may be generalized throughout the system such that other Folder types may take advantage of its “delayed” update nature.

According to one embodiment of the invention, the invention may include a mechanism for dealing with “incomplete” or “hollow” system objects (e.g., a file). An object may be deemed incomplete or hollow because only header information may be available (e.g., title, author, date) and not the contents. Hollow objects may be used in situations where the contents of a message are large enough (e.g., a large video file) to require/desire for a separate and/or optional retrieval of the object contents. Accordingly, the invention may incorporate mechanisms for displaying hollow documents in the user interface, allowing the user to manually request the retrieval of the object's contents, and/or scheduling the automatic retrieval of object contents.

According to one embodiment of the invention, a project folder and its associated sub-folders may comprise first-class objects according to the system of the invention, with a number of characteristics. One such characteristic may comprise a user identified as the leader of a project. Changes to a project's characteristics may be made with an UpdateProject transaction sent to some or all participants. The project leader may transfer leadership of the project to another participant by sending an UpdateProject transaction with the new leader listed as the leader of the project. This feature may be important because, in a distributed, loosely-coupled collaborative space, users need the freedom to re-organize as the work demands shift. Similarly, a project leader may appoint different participants to be “owners” of one or more project sub-folders. The project leader or the current folder owner may transfer the folder “owner” role to others via an UpdateFolder transaction sent to some or all participants. This feature may be important because in a distributed, loosely-coupled collaborative space, users need the freedom to re-organize as the work demands shift.

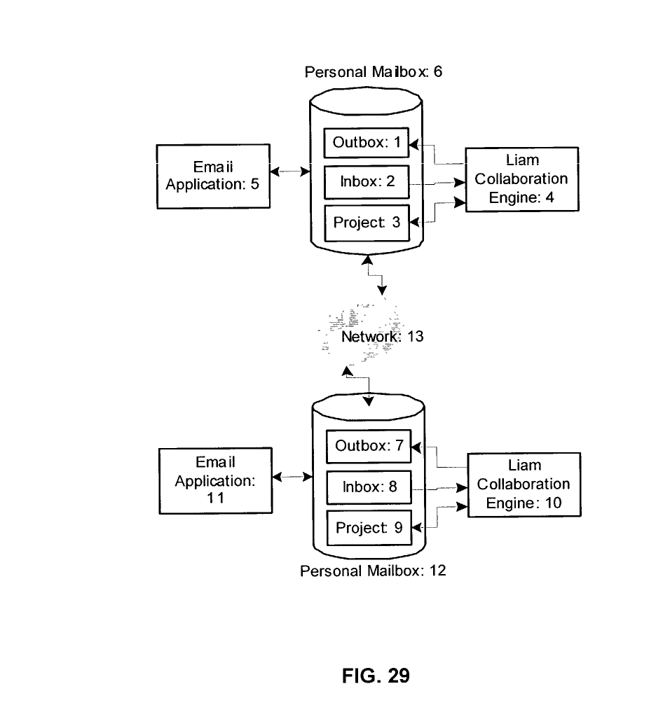

The foregoing features and functionality as described and illustrated in the various screen displays may be provided according to a system as shown in FIG. 29. The system may include personal mailboxes (6, 12) of an electronic mail application (5, 11) for electronic mail users who are participants in the same project. Personal mailboxes (6, 12) may communicate over a network (13). The personal mailboxes (6, 12) may reside on a personal computer, laptop computer, workstation or other client device. The client devices preferably also have a Collaboration Engine (4, 10) for providing an electronic mail application with integrated collaborative space management. Personal mailboxes (6, 12) preferably include outboxes (1, 7), inboxes (2, 8), and project storage (3, 9). Outboxes (1, 7), inboxes (2, 8), and project storage (3, 9) may each communicate with respective Collaboration Engines (4, 10). Electronic mail application 5 may directly interface with personal mailbox 6 for sending electronic mail through outbox 1 and receiving electronic mail through inbox 2.

Collaboration Engine 4 may add project storage 3 for enhanced collaborative features such as, for example, project spaces, threaded discussions, files, project calendar, tasks, etc. Collaboration Engine 4 may also be responsible for ensuring that project spaces 3 are also stored in project storage 9 and that they remain synchronized. Any additions or changes taking place in, for example, project space 3 may be propagated to project space 9 thus essentially creating a distributed network of shared spaces.

Collaboration Engine 4 may leverage an existing messaging infrastructure by, for example, detecting file additions to a project storage 3, creating an outgoing message to transfer the file to project store 9, attaching the file to the message, appending an XML formatted S/MIME part containing the necessary command and project attributes to allow a recipient's Collaboration Engine 10 to automatically place the file in an appropriate project in the participant's project storage 9, if necessary, encrypting the message with the recipient's public key, sending the message, and leveraging the participants messaging infrastructure. The message with the attached file and Collaboration Engine S/MIME part may be received at inbox 8. Collaboration Engine 10 retrieves the message, decrypts the message with the participant's private key, reads the Collaboration Engine S/MIME part to determine how the message should be processed, detaches the file, and places the file in project store 9.

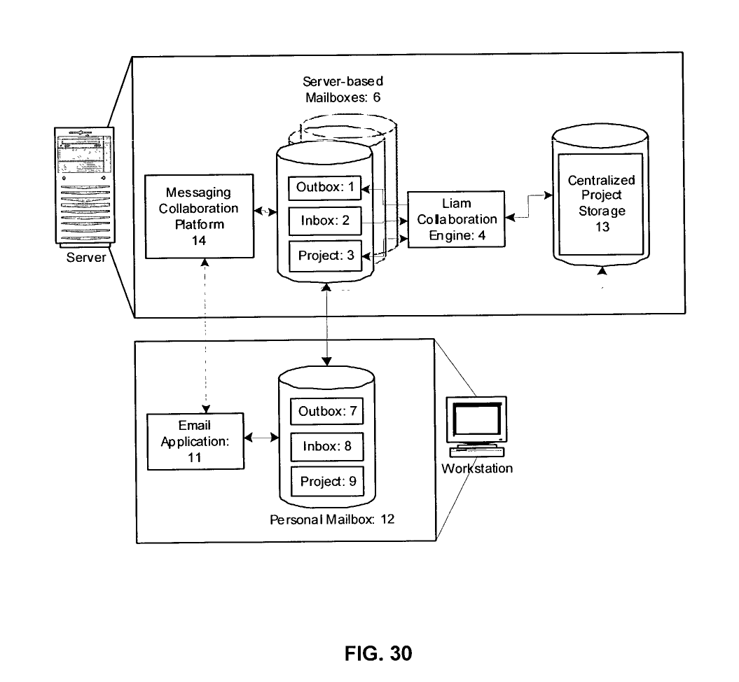

According to another embodiment of the invention, the system of the invention may be installed as a server configuration as shown in FIG. 30. A server may communicate with a user's workstation. The server may include a plurality of server-based mailboxes 6 for a plurality of users, a messaging collaboration platform 14, a collaborative space management Collaboration Engine 4, and a centralized project storage 13. Server-based mailboxes 6 may include an outbox 1, inbox 2, and project space 3. Server-based mailboxes 6 may interface with messaging collaboration platform 14 for sending and receiving electronic mail, Collaboration Engine 4 for managing projects, and centralized project storage 13 for retrieving information for the projects. Collaboration Engine 4 may also interface with centralized project storage 13 that stores projects for a plurality of users.

The server may interface with a user workstation. The workstation may include an electronic mail application 11 and a personal mailbox 12. Personal mailbox 12 may include an outbox 7, inbox 8, and project space 9. Personal mailbox 12 may be an off-line version of server-based mailboxes 6. Electronic mail application 11 may interface with messaging collaboration platform 14 to provide access to server-based mailboxes 6. The server configuration enables the project storage to be centralized in a server as opposed to user's workstation. Project folders stored across various platforms, mailboxes, and organizations may be synchronized using Multipurpose Internet Mail Extension (MIME) Part and a Collaboration Protocol.

The MIME—or S/MIME when encrypted and signed—part used by the system to encode commands, command arguments, and data in Extensible Markup Language (XML) format, independent of collaborative platform. The MIME Part facilitates the transfer of messages, events, tasks and other project content across different collaborative platforms (e.g. Microsoft Exchange™ and Lotus Notes™). The MIME part may also be used to implement the collaboration protocol. The collaboration protocol may include XML-formatted commands and data exchange protocol stored in mail messages as a MIME or S/MIME Part and may be used to reconcile updates to collaborative spaces across different collaborative platforms (e.g. Microsoft Exchange™ and Lotus Notes™). Examples of commands may be, for example, Invite Participant, Accept, Decline, Add Message/File/Event/Task/Object, Update Message/File/Event/Task/Object/Participant, Delete Message/File/Event/Task/Object/Participant, Propose Participant, Un-invite Participant, Request Message/File/Event/Task/Object/Participant, and Request Synchronization.

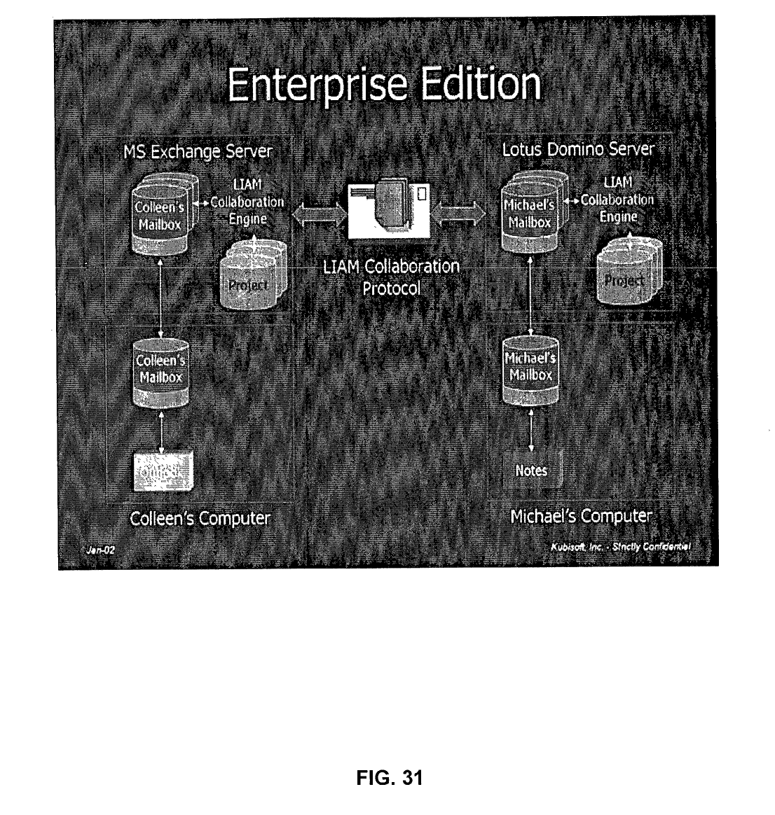

FIG. 31 illustrates an enterprise configuration that may be used in conjunction with multiple platforms, for example, a Microsoft Exchange™ platform and a Lotus Notes™ platform. A client device running Microsoft Outlook™ may include a client-side mailbox. The client-side mailbox may communicate with a server-side mailbox of a Microsoft Exchange™ server. The server-side mailbox may communicate with a Microsoft Exchange™ server Collaboration Engine that provides collaborative space management. The Microsoft Exchange™ Collaboration Engine may communicate with a Project repository that stores information relating to, for example, projects associated with a user.

The Microsoft Exchange™ Collaboration Engine may communicate with a Collaboration Protocol that enables the Microsoft Exchange™ Collaboration Engine to communicate with servers that may be on the same or a different platform. As shown in FIG. 31, Microsoft Exchange™ Collaboration Engine may communicate with a Lotus Domino™ server using the Collaboration Protocol. The Lotus Domino™ server may include a Lotus Domino™ Collaboration Engine that communicates with a project repository that stores project information associated with a user of Lotus Notes™. The Lotus Domino™ Collaboration Engine may also communicate with a server-side mailbox that communicates with a client-side mailbox of a Lotus Notes™ user using a client device.

According to one embodiment of the invention, project participants communicating using different platforms, for example, Microsoft Exchange™ and Lotus Notes™, may not be aware that other project participants are running a different platform. This is because messages in a projects folder may appear in a format that corresponds to the platform that the participant is running. For example, one project participant may be operating on a Microsoft Exchange™ platform and another participant of the same project may be operating on a Lotus Notes™ platform. When messages are created by each of these participants, the messages are created in their respective platform format. This format may differ for messages created using a different platform. When messages are received, however, the system of the invention determines the platform used to create the message. If the format of the message differs from the format used by the system that received the message, the message is presented in the format used by the system that received the message. This enables participants to view messages in a familiar format and manipulate the messages in a known manner.

According to one embodiment of the invention, electronic mail users without access to the collaborative system may be afforded the opportunity to participate in a project. An “email-only-participant” may join a project by responding to an invitation without downloading, accessing, or installing the system software. Of course, an email participant may become a fill participant at any point by downloading, accessing, or installing the system software. Email participants may receive changes/additions to a project space via electronic mail messages optionally formatted in HTML with contextual information. For example, when a new message is added to a discussion folder, email participants may receive a message containing the subject and contents of the message. In addition, they may also receive, as part of the message, the context—the applicable list of messages in the discussion—in which the message was created. For example, if an email participant receives a reply to another message, they may also receive a “snapshot” of the message thread as well.

Similarly, when a new task is added to a project task folder, an email participant may receive an electronic mail message including the task, as well as any related or pertinent content from the task folder. The same process may also apply to new calendar events and files placed in the project file folder, as well. Any responses submitted by an email participant may be placed in the project space of some or all of the other project participants. According to an embodiment of the invention, email participants may also select to receive a daily or weekly summary of the status of a project.

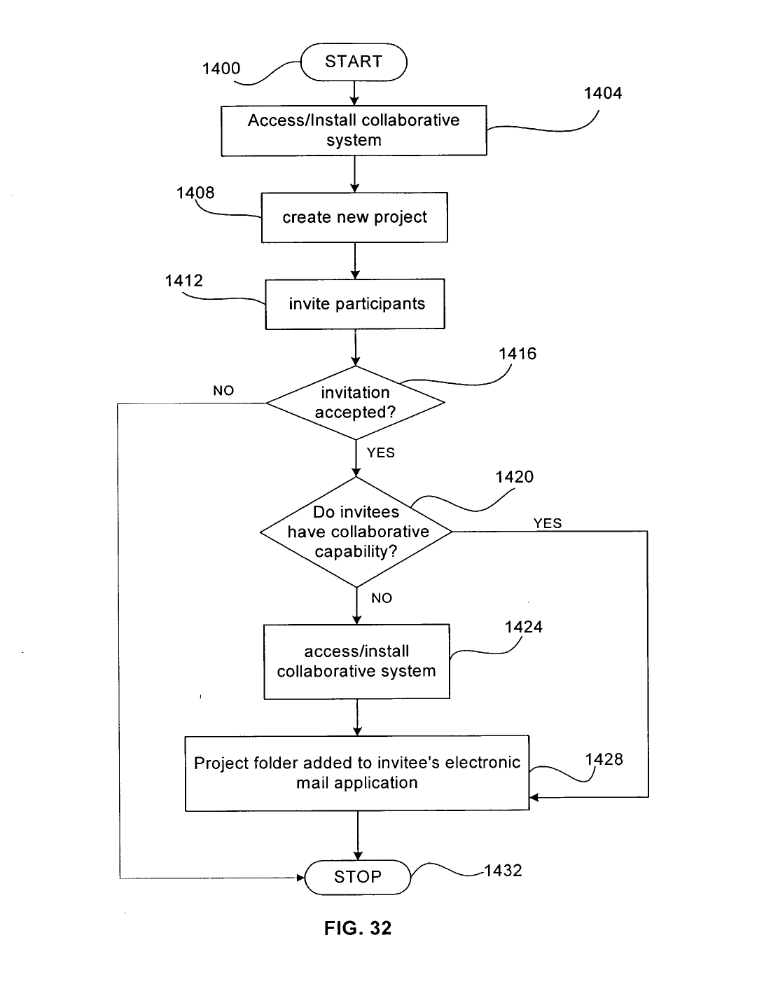

FIG. 32 illustrates a flowchart of processing according to the invention, in one regard. Processing may begin at step 1400. In step 1404, a user may install a system that provides a collaborative electronic mail application and infrastructure that allows users to create projects where messages, files, calendar events, tasks, and other user-defined content and workflow processes may be securely shared with other project participants regardless of a user's system platform or location. The collaborative system may be installed on a client device or a server. Preferably, after installation initiation by the user, the system installs and configures itself automatically to function with the client device or server platform. The system may provide a graphical user interface that is completely integrated and fully consistent with a client or server platform, for example, Microsoft Outlook™, Lotus Notes,™ or other platform. Once installed and operational, the system may indicate that a projects folder has been added to the user's mailbox and is ready for a new team project to be created.

A user (or project leader) may create a new project in step 1408, and may, in step 1412, invite another user to be a participant in the project. The system may send the invitation using the Project Leader's mail infrastructure. The system may append a MIME Part to the invitation that includes an Invitation command, Project id, and Project Leader's public key. The invited user may receive the invitation as a standard electronic mail message.

In step 1416, a determination may be made regarding whether the invited user desires to accept the invitation and become a part of the project. If the invited user declines the invitation, processing may end at step 1432. If the invited user accepts the invitation, however, processing may continue in step 1420.

In step 1420, a determination may be made regarding whether the invited user has access to the collaborative system. If an invited user has access to the collaborative system already (e.g., the user is a current or past participant on another collaborative project), then processing may continue in step 1428. If a user does not have access to the collaborative system, he or she may download and install the software for the system of the invention in step 1424. According to one embodiment, the electronic mail message containing the invitation to join a project may also include information (e.g., a hypertext link) that enables the user to access and/or install the software for the collaborative system. If necessary, the system may generate a security certificate (that may include a public and private key) for the invited user. Otherwise, the system may use the user's existing secure mail certificate. The user may accept the invitation to join the project and become a participant in the project. The system may append the MIME Part and sign and encrypt the message (S/MIME) with the Project Leader's public key. The Project Leader may receive the acceptance message from participant. The system may unpack the S/MIME Part, decrypts the MIME part, verify the authenticity of the message and its author, store the participant's public key and proceed to send to participant the current project data. The data may be sent as encrypted messages with the appended MIME Part as appropriate.

In step 1428, a user that has accepted an invitation to join a project may have the project folder added to their electronic mail application so that they may begin to receive the project data. At this point, a participant may have access either all or some of the features associated with the collaborative workspace. For example, to create a calendar event, a participant may create an appointment in a project's calendar. The system may convert the event to a platform independent format and together with an Add Event command, and possible other arguments such as, for example, a project's identifier, compose a message, encrypts the message, and send the message to all project participants. A receiving participant's system may decrypt the message, converts the message to the participant's collaborative platform format, and place the message in an appropriate project folder. Processing may end at step 1432. It is important to understand that the foregoing process description should not be viewed as limiting. All of the features and functionality disclosed in the detailed description and illustrated in the accompanying drawing figures may be incorporated. For example, a user that has accepted an invitation in step 1416 may select not to access, download, or install the collaborative system software in step 1424. Rather, the invited user may select to be an “email-only-participant” as described above.

According to one embodiment of the invention, various synchronization and data security features, and protocols, are provided to ensure that the integrity of the collaborative workspace is maintained for all participants associated with a project, regardless of their platform.

According to one embodiment of the invention, a POP3 proxy may be incorporated into the system of the invention to read an e-mail stream into an alternative message store. Preferably, the system of the invention utilizes rich access to a participant's inbox to properly process the xml-tagged messages that form its protocol. In some configurations where that style of rich access may not be possible, a user may retrieve their email using the standard POP3 protocol. In these configurations, the system of the invention may use a local POP3 proxy to read email arriving at a participant's inbox, and copy appropriate messages into its own datastore for rich processing.

According to one embodiment of the invention, a Relaybox (a mailbox supporting the POP3 and SMTP protocols for receiving and sending email) may be incorporated into the invention when, for example, a participant's own email server does not support POP3 access (as may be the case with AOL and/or MSN/Hotmail). The Relaybox may be hosted by a server and may be created and assigned to a participant as part of the participant's registration prior to accessing, downloading, or installing the software for the collaborative system.

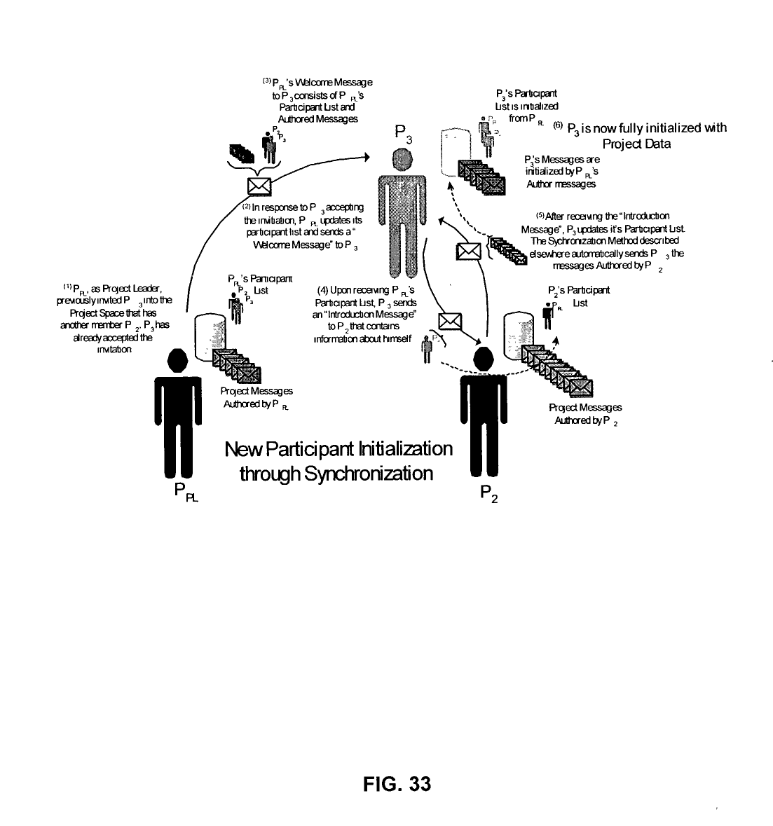

According to one embodiment of the invention, and as illustrated in FIG. 33, a synchronization method for synchronizing new project participants is provided. Generally, and with reference to the new participant initialization methods and functionality described above, new participants may receive all appropriate project messages and/or files that have been generated during either part of all of the lifetime of the project. According to one embodiment, the system may view the author of a message as the owner of the message, and thus hold the owner responsible for making sure that all participants are in sync. According to this approach, two types of message “classes” may exist. The first may comprise a “Welcome Message” that a Project Leader sends to the new participant after the new participant accepts the invitation. The second may comprise an “Introduction Message” that the new participant sends to each of the existing project participants. Both of these messages may be auto-generated by the system and may not require any end-user intervention. These messages may also have a suitable “plain-text” body that makes sense for non-system users and for views from within the Inbox. Such a plain-text body may comprise something like: “Welcome to Project X. I am John Doe, the Project Leader for this collaborative space.”

The Welcome Message may contain, as control data within the MIME Part, a Project Leader's (since the PL may be the only person who can invite new participants) Participant List and the Project Leader's collection of Authored Messages (limited to any size and/or date thresholds). These Authored Messages may either be full messages or Hollow Messages, as described above. With this information, a new participant is able to learn the identity of others in the Project Space.

After receiving the Welcome Message, a new participant may send an “Introduction Message”, to each of the existing participants in the project space. Like the Welcome Message, this message may be auto-generated by the system and may have a suitable “plain-text” body for non-system users and for views from within the Inbox. Such a plain-text body could comprise something such as: “Hello, my name is Sally Jones. I have just been invited to participant in Project X.” As part of the system MIME command message, the Introduction Message may also contain information about the new participant, e.g. contact info, etc. Since this Introduction Message may be sent to each of the existing participants, the auto-synchronization system (described in detail below) that may be running on each of the existing participants, may automatically notice that the new participant is missing messages that each given existing participant has authored. Applying predetermined thresholds set for size and/or date constraints, each existing participant may automatically send—without any intervention on behalf of the end-user—all project messages that that specific existing participant has authored in the past.

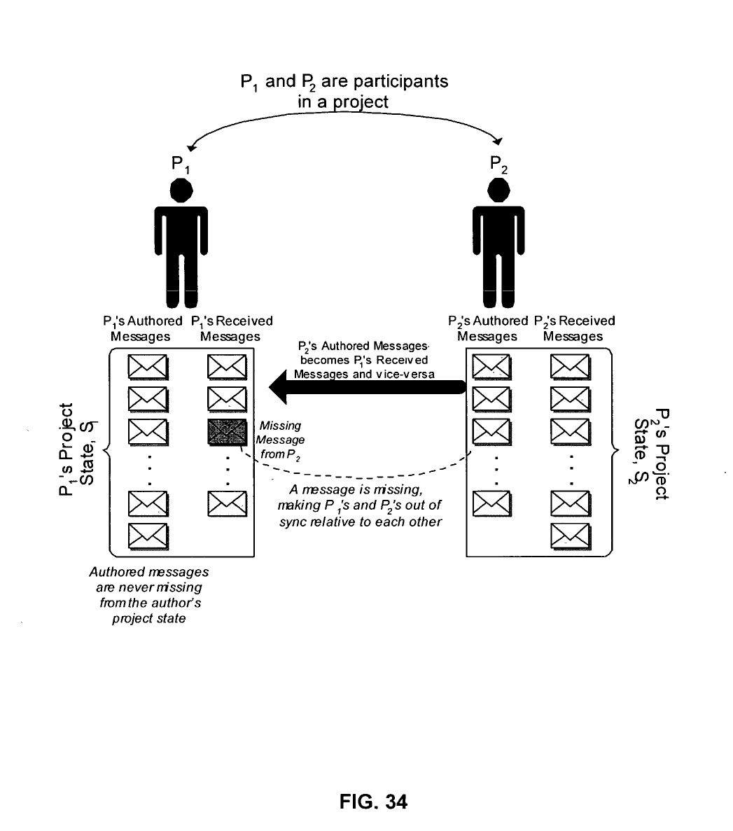

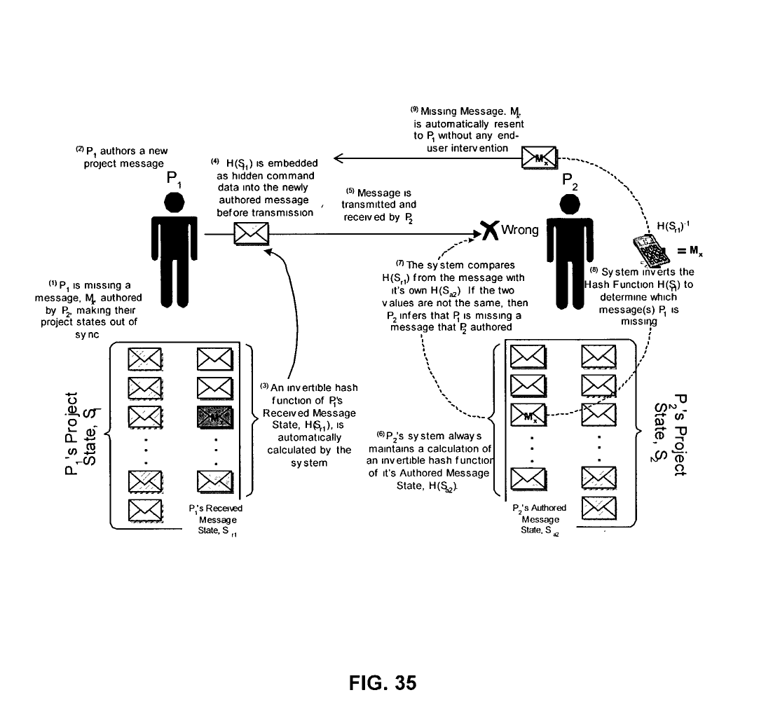

According to one embodiment of the invention, and as illustrated in FIGS. 34-35, a method for identifying when one or more participants are in an “out-of-sync” state with regard to a collaborative workspace may be provided by forming a compressed representation of a list of project messages. For each message in a given list of messages, a hash value may be computed from a hash function that may only represent a function of the message itself and nothing else. These hash values may then be summed together and transmitted to a receiver participant. The receiving participant may then look into it's message store, calculate a hash value for each of it's messages, and sum them. The system of the invention may then compare the two resultant sums. If they are not equal, then the project state is likely out of sync.

In addition to quickly identifying when two participants are out of sync, it may also be possible to determine which messages from a list are missing. According to one embodiment of the invention, this first step may be performed by a sender of a new message. For each message in a given list of messages that a sender has received from a current recipient prior to a current message, a hash value may be computed from a hash function that is only a function of the message itself and nothing else. These hash values may then be summed together and transmitted to a receiver participant. This hash value may then be transmitted along with a new message body to the receiver participant. The receiver participant may then examine its message store, identify and isolate all prior messages that it has sent to the author of this new message, calculate a hash value for each of its messages, and sum them. The system of the invention may then compare the two resultant sums. If they are not equal, then the project state may be out of sync.

Once an out of sync status has been identified, it may now be possible to identify which document is missing. Since the sync ID value is a linear equation, a weighted sum of parts, with a strong constraint of the coefficient weights to either be a one (document is present) or a zero (document is not-present), it is computationally feasible to solve this linear equation within reasonable time. The number of combinations of documents present and not-present is 2^{N} where N is the number of total documents. Since this sync operation is done often (therefore N will typically be a small number), and the “out-of-sync” state is the rare exception, the system of the invention may “brute-force” calculate the permutations and identify the missing documents. Once the missing documents have been identified, they may be resent.

According to one embodiment of the invention, participants may assign a local-area or corporate wide-server to be his/her datamaster, retaining an archive of all project messages. The datamaster, through email gateways and other messaging event processing, may then automatically intercept messages, properly classify the messages, and stores the messages appropriately.

A datamaster server may work with an arbitrary number of client machines. This feature allows for a more reliable and automatic synchronization, as server machines are typically always “on” and processing incoming email messages. Since this designated master is always monitoring message traffic on the project, it can respond to sync requests from other participants.

According to one embodiment of the invention, three types of synchronization schemes may be utilized for data synchronization.

First, using a listener synchronization, the sender of a project message may include a list of prior messages (either a summary itemization or some compressed representation) that he/she (the sender) has received from each of the outgoing message recipients. The receiver of this new message may check this list of prior messages against that which the receiver knows that he has sent prior to receiving this message. If there is an item missing, then the system may automatically resend the missing message. In this method, there may be an “invisible, silent” acknowledgement that is driven through the generation of new messages.

Second, using a talker synchronization, the sender of a project message may include a list of prior messages (either a summary itemization or some compressed representation) that he/she (the sender) has previously sent. The receiver of this new message may check this list of prior messages against those that the receiver had previously received. If there is an item missing, then the system may generate a “message request” back to the sender for the missing prior message to be sent again.

Third, a hybrid synchronization may utilize both the listener and talker synchronization methods to counter balance the pros/cons of each. The listener method is advantageous since there may be no need for an additional “message quest,” thus reducing traffic. However, a listener method may only check for synchronization when someone authors a new project message. Therefore “email-only” participants may not get an opportunity to monitor sync. However, the talker method may keep “email-only” participants in sync, but may require that “message requests” (a command-only message) be generated and processed.

According to one embodiment of the invention, in the listener method of synchronization, project participants may be more likely to get out of sync, since synch-checking may be performed only when participants author new messages. Accordingly, the system may monitor each participant for his/her level of activity within the various project space. If the system, on an “email-only” participant's system, notices (given some settings and heuristics) that its corresponding project participant has not been very active on a given project, it may automatically generate a “Hello” message and send it to the project. Since this is a message that is authored on behalf of a participant, it may allows for a synchronization opportunity to occur.

According to an embodiment of the invention, participants may be afforded varying levels of access to project folders or subfolders. Access Control Lists (ACLs) may, for example, be used to enforce access levels for participants to read, write, author, or update messages. Accordingly, it may not be uncommon for participants to be viewing only designated subfolders that are relevant to their portion of the project. As such, when one participant generates a new message, only those having the proper access level to view that message may receive it. This means that each project state, or the collection of project messages, may not be constant with respect to each participant unless everyone has the same access level. Generally speaking, some people will see all project messages, while some will be able to view a smaller subset of messages.

According to one embodiment of the invention, functionality may be incorporated into the invention to synchronize a collaborative project space when project states are not necessarily uniform across all participants due to varying access levels among participants. The system may, for example, retain knowledge that, for every message, maps the message to it's recipients. Therefore, in the Listener and Talker Synchronization methods described above, the system will know which messages were intentionally not sent to a given participant (due to access restrictions) and those messages that are missing.

ACL changes to a particular participant (e.g., giving additional rights or removing privileges from a project space) may be done by a Project Leader who has Administrative Rights to the Project. However, since ACL rules may be performed locally on every participant's machine it is important that the ACL rules are maintained in highest of synchronization across the entire project space.

According to one embodiment of the invention, an auto-updating feature may be incorporated for participants whose access level has been changed. For example, assume that a participant's access level has been changed to a “less restrictive” setting, meaning that they are now entitled to access a subfolder that they originally did not have rights to. The sub-folder for the participant may need to be auto-synched with the project folder to ensure that the participant receives all of the messages that he or she were previously not permitted to have. Accordingly, when a change is performed to the Project ACL, an Access Level Change notification message may be sent to all project participants that includes the newly updated ACL. Upon receiving this message, the system may automatically parse out all of the applicable information and update its own internal ACL. From that point forward, the system may apply those rules from the new ACL. When a participant receives a message (from a Project leader or other individual) informing them of their new “less restrictive” access, that participant may automatically receive all prior messages were not previously accessible.

The invention may also, in various embodiments, incorporate synchronization capability to handle electronic mail messages that may not be delivered due to delivery failures. Outgoing messages may sometimes fail to be delivered (SMTP failures). This failure may occur immediately (e.g., bad email address) or be delayed (up to several days). The system may monitor incoming email messages from email servers, either via POP3, IMAP, or Echange/Notes protocols and be able to detect these delivery failures due to standardized SMTP error codes. If this problem persists, based on a configurable threshold, there may be a UI event which notifies the end-user that a given participant is no longer reachable. In this case, the end-user mayl decide whether to suspend delivery to that participant until further notice, or to keep trying with future messages. If the end-user chooses to suspend delivery to that participant, it may comprise a local-only change to the Participant List since the delivery failure may only affect the email routing between those 2 people. At this stage, it is known that the receiver may be out of sync. Once he/she is reachable again through whatever means, the system on the author's machine will perform a synch operation and the delivery mechanism will be attempted once again.

According to one embodiment of the invention, a technique is provided for detecting and synchronizing a user opening a web-mail message—with the project in which that message exists. As previously described, the system provides shared collaborative spaces to a wide range of email clients. At the low end of the rich-access spectrum are web-based email providers (e.g., AOL, Yahoo, or Hotmail). One of the objects of the invention is to allow a user to participate via their familiar email client. For these web-based users, that is the web browser. As such, the system may include a web browser add-in that may detect the actions that a user is taking in the web browser by watching the URLs clicked-on. When a mail message is opened, the same message may be found in a local system database, which may be maintained either with a POP3 proxy or a relaybox, as described in detail above.

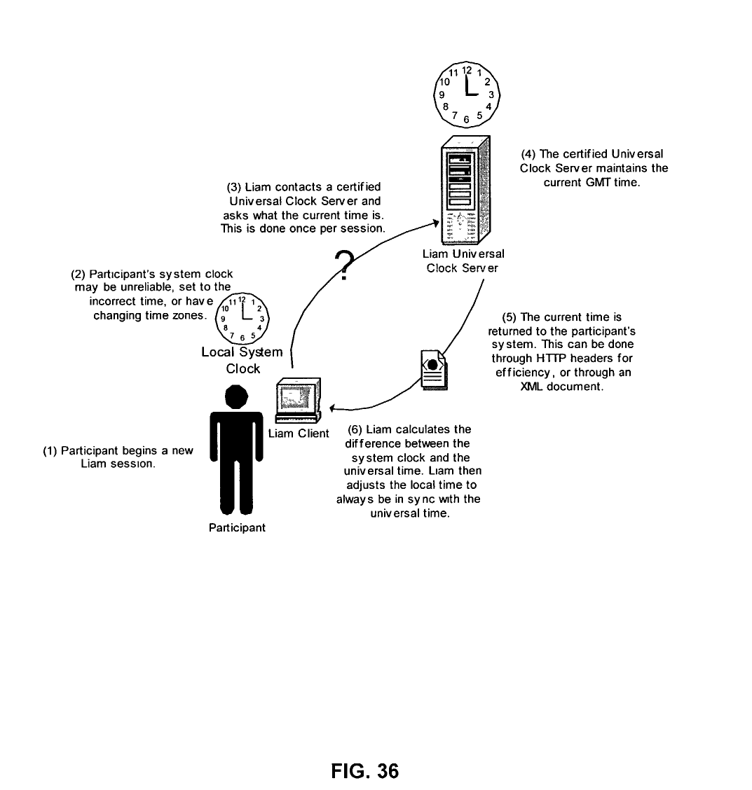

According to one embodiment of the invention, and as illustrated in FIG. 36, the system may comprise one or more designated Universal Clock Servers to obtain reliable timestamps on project messages and/or transactions, and to account for discrepancies that may exist among the individual system clocks of participants in a project. These discrepancies may exist due to incorrect (bad settings), or when participants are dispersed across one or more time zones.

Reliable timestamps may be important because they ensure that the context of a discussion thread, for example, is preserved in its proper chronological order. According to one embodiment, the Clock Servers may be set to use Greenwich Mean Time (GMT). Any localized time settings such as Eastern Standard Time (EST) will be automatically converted to use GMT. Each participant's system may be configured to synchronize its own clock with a designated clock server upon the commencement of each session. The synchronization may occur by taking the time information returned from the Clock Server and having the participant's system subtract it's own local time to generate a delta-t, the difference between it's own clock and the universal clock.

For every instance when a message or transaction occurs, and/or a timestamp is needed (e.g. authoring a new message, file updates, etc.), the system may get the local system time and then add the delta-t (as described above) to make every system timestamp an absolute clock reference. It is important to recognize that, in theory, there may be some latency in receiving the clock information from the Universal Clock Server, due to Internet traffic, requestor's connection speed, or server load, causing a small error in the calculations. Therefore the time returned from the server and the time received from the clock requestor may have some built-in error. However, in practice, this error may be small enough not to have a significant role in generating accurate timestamps for system synchronization purposes.

According to one embodiment of the invention, the Universal Clock Server may simply comprise a regular web server that returns the time in the HTTP reply header. This may minimize the size of the clock synchronization message, reducing server load and Internet traffic, therefore improving performance. However, other methods of implementation are viable.

According to one embodiment of the invention, security measures may be implemented to ensure that the confidentiality and integrity of transmitted project messages is maintained. For example, system transactions may be encoded as xml data in an alternative MIME part of a standard email sent by standard means to a user's inbox. To prevent unauthorized actions, each transaction may encrypted and signed.

Each transaction may further include an embedded identifier to prevent an attacker from recording and replaying transactions. The identifiers may comprise sequential numbers assigned by each sender. A Participant's system may record the transaction ids that have been executed for each sender, and will not execute duplicates, preventing a replay attack. This may also protect against one form of unreliability in the email transport: message duplication.

Although the system protocol is, according to one embodiment, based on xml-tagged emails, circumstances may arise in which untagged emails find their way into the transaction stream. The first may arise if non-system users reply to project messages, and The second may arise if system users can work directly from their inboxes. The system may accommodate such untagged messages into the command stream even though they are untagged. The system may accomplish this by using a In-Reply-To RFC822 header to find the previous system message being replied to, and then inferring the information missing from the tagged data.

According to one embodiment of the invention, additional security functionality may be provided to enable the authentication of project commands/messages. In the system, all project participants may be issued certificates such that all messages that have been authored by a participant will be digitally signed with the system-generated certificate. This “signature” may be used within the S/MIME specification for digital signed messages so that it may interoperate with S/MIME compliant email browsers such as Outlook Express, Outlook, and Notes. Furthermore, since each message may have a unique tag, and the system may track which message tags have been received and processed, it may not be possible for an intruder to “copy” messages and re-send them posing as the author. This represents another level of protection that may prevent unauthorized commands to be sent.

According to one embodiment of the invention, the system may generate public/private and symmetric keys on a project-by-project basis. For example, each participant may be assigned his or her own private/public key. If a user does not have a private/public key already installed (from Verisign, for example), the system may automatically generate one and publish it to the project space. The system may be based on S/MIME secure messaging techniques, and may therefore utilize “enveloped data” whereby a symmetric key may be automatically generated for every message. This symmetric key may then be used to encrypt the body and any associated data of the message. Then, the symmetric key may be encrypted once for every recipient of the email with his/her public key. This technique may be used to increase performance, as it may be quicker to use symmetric key algorithms rather than public/private key algorithms for large datasets.

The system may also work, as a project configuration setting, by generating symmetric keys on a project basis and then use that single symmetric key to encrypt all messages. The project-wide symmetric key may be published to the project participants in a secure manner using the participants private/public key. Using a single, project-wide symmetric key may allow for a system administrator to recover the original data, should a participant lose his/her certificate or have it accidentally revoked.

According to one embodiment of the invention, a method may be provided for generating and managing secure communications over open protocols. The system may, for example, use X.100 standard certificates that are used in conjunction with S/MIME secure messaging. When operating, the system may first attempt to locate a certificate for the participant. If a certificate is not found on either a LDAP server, Exchange/Notes Server, or local machine, a system-authenticated certificate may be generated on behalf of the end user. This certificate may contain both a public and private key. When a participant is invited, he/she—as part of the “Introduction” message—may publish his/her public key to all other project participants. This public key may be embedded within the data section of the message. If an intruder intercepts this message, no harm may be perpetrated as only the public keys are published. If there are any updates to the certificate stores (e.g. a participant obtains a new certificate), it may be published to all participants.

Some or all project messages may also, according to an embodiment, use an enveloped technique, whereby the message content is encrypted with a one-time symmetric key, as per the S/MIME spec. Within the encrypted body, the message may expose the symmetric key (for decrypting) by encrypting the key with the public key. Therefore, only the receiver that has the private key may decrypt the symmetric key, and then decrypt the actual message. The system may further store all project data in an encrypted format, since the underlying datastores may be easily accessible via several API's.

According to one embodiment of the invention, a method may be provided for embedding receipt acknowledgement within outgoing messaging. Upon receiving a message from another participant, and rather than sending a confirmation message when the message has been received and/or opened, a method may be employed that embeds the receipt acknowledgement within a naturally occurring (i.e. user driven) email message. The system may queue up references to messages that have been received since the last time a participant authored a Project message himself. When the participant naturally wishes to author a new message within the project space, the system may automatically determine which messages have already been received—given a timestamp from the Universal Clock Server—from each of the other participants. A separate list of received messages may be maintained for each project participant. This is called an Acknowledgement Queue, and every participant may maintain an acknowledgement queue for each of the other participants. If there are N number of participants in a project space, then every participant may maintain N-1 Acknowledgement Queues.

Other embodiments and uses of the invention will be apparent to those skilled in the art in consideration of the specification and practice of the invention as disclosed herein. The specification and examples should be considered exemplary only. For example, although the invention has been described in terms of a project, other implementations of collaborative spaces (e.g., Groove.net, eroom.net, lotus.com, Lotus Quickplace™) integrated as a part of a user's electronic mail environment and leveraging the messaging infrastructure of that environment may be used.

What is claimed is:

1. A computer-implemented electronic mail application system comprising:
an electronic mail module and an integrated collaborative workspace module, the collaborative workspace module, comprising:
means for enabling a first user to create a collaborative workspace; and
means for enabling the first user to view the collaborative workspace in the electronic mail application.

2. The system of claim 1, wherein the collaborative workspace module enables the first user to invite one or more other users to participate in the collaborative workspace.

3. The system of claim 2, wherein an invited participant has an electronic mail application and an electronic mail address, and the collaborative workspace module sends an invitation to participate in the collaborative workspace to an electronic mail address of an invited participant via the electronic mail module.

4. The system of claim 3, wherein the collaborative workspace module further sends to an invited participant, information to enable the collaborative work space module to be integrated with the invited participant's electronic mail application, if the invited participant accepts the invitation and the collaborative work space module has not previously been integrated in with the invited participant s electronic mail application.

5. The system of claim 1, wherein the first user's electronic mail module comprises a first user mailbox, and the collaborative workspace module comprises means, in response to the first user creating a collaborative workspace, for creating a folder for the collaborative workspace in the first user mailbox.

6. The system of claim 5, wherein the collaborative workspace comprises a plurality of collaborative object types, and the collaborative workspace module comprises means for creating in the collaborative workspace folder, a plurality of sub-folders corresponding to the plurality of collaborative object types.

7. The system of claim 2, wherein the invited participant's electronic mail module comprises a second user mailbox, and the collaborative workspace module comprises means, in response to the invited participant accepting an invitation to participate in the collaborative workspace, for creating a folder for the collaborative workspace in the second user mailbox.

8. The system of claim 7, wherein the first user's electronic mail module comprises a first user mailbox, and the collaborative workspace module comprises means, in response to the first user creating a collaborative workspace, for creating a folder for the collaborative workspace in the first user mailbox, wherein the folder created in the first user mailbox has a folder name, and the folder for the collaborative workspace in the second user mailbox is automatically created with the same folder name.

9. The system of claim 7, wherein the collaborative workspace comprises a plurality of collaborative object types, and the collaborative workspace module comprises means for creating in the collaborative workspace folder, a plurality of sub-folders corresponding to the plurality of collaborative object types.

10. The system of claim 8, wherein the collaborative workspace comprises means for replicating the collaborative workspace folder in the first user mailbox and the second user electronic mail application.

11. The system of claim 4, wherein the first user has an electronic mail application of a first type arid the second user has an electronic mail application of a second type, wherein the collaborative workspace module enables the first user to see the collaborative workspace in the first type electronic mail application environment and the second user to see the collaborative workspace in the second type electronic mail application environment.

12. The system of claim 11, wherein the first and second electronic mail applications each comprise an electronic mail application selected from the group consisting of Lotus Notes, Microsoft Outlook, and AOL Mail.

13. The system of claim 7, wherein the first user mailbox comprises an inbox and second user mailbox comprises an inbox, and wherein the collaborative workspace module sends to participants of the collaborative workspace via the electronic mail module an electronic mail message regarding a change to the collaborative workspace.

14. The system of claim 1, wherein a user can view an electronic mail message simultaneously via an inbox view of the electronic mail module, and via a collaborative workspace folder view of the collaborative work space module.

15. The system of claim 14, wherein the collaborative workspace folder view displays the electronic mail message in the context of other activity of the collaborative workspace.

16. The system of claim 14, wherein the collaborative workspace folder view displays the electronic mail message in the context of other activity of that object type in the collaborative workspace.

17. The system of claim 9, wherein the object types comprise one or more of electronic mail messages, a calendar, tasks, discussions, documents, participants and other object types.

18. The system of claim 9, wherein the collaborative workspace module comprises an access control module that enables an authorized user to control whether a particular folder is open to all participants in the collaborative workspace or at least partially restricted.

19. The system of claim 1, wherein the collaborative workspace module comprises means for enabling participants to annotate content stored in a project folder or a sub-folder created in the collaborative workspace.

20. The system of claim 19, the collaborative workspace module further comprising annotation access control means for enabling a participants to control whether a particular annotation is open to all participants in the collaborative workspace or at least partially restricted.

21. The system of claim 1, wherein the collaborative workspace module comprises means for enabling participants to create one or more personal sub-folders in the collaborative workspace folder.

22. The system of claim 21, the collaborative workspace module further comprising sub-folder access control means for enabling a participants to control whether a personal sub-folder is open to all participants in the collaborative workspace or at least partially restricted.

23. The system of claim 20, wherein annotations that are at least partially restricted are only replicated to participant's permitted access to the annotations.

24. The system of claim 22, wherein personal sub-folders that are at least partially restricted are only replicated to participants permitted access to the personal subfolders.

25. The system of claim 1, wherein the collaborative workspace is stored on a local storage device of a terminal device.

26. The system of claim 1, wherein the collaborative workspace is stored on a local storage device of a terminal device and on a server accessible by the terminal device.

27. The system of claim 2, comprising means for providing a protocol that will enable the replication of the collaborative workspace in the electronic mail application of any user that accepts the invitation, regardless of which platform the accepting user's electronic mail application is running.

28. The system of claim 1, wherein the collaborative workspace module further comprises means for monitoring content in the collaborative workspace such that changes to the content made by any user will be propagated into the collaborative workspace of other participating users.

29. The system of claim 2, wherein the invitation includes a link to a location that enables a participant to download a collaborative workspace module.

30. The system of claim 1, wherein the collaborative workspace comprises collaborative objects, and the collaborative objects are transmitted, via electronic mail, to all users participating in the collaborative workspace.

31. The system of claim 30, wherein the collaborative objects are converted to an independent format and are viewable in a user's electronic mail application.

32. The system of claim 1, wherein the collaborative workspace is in a web page, web site, or web application.

33. The system of claim 1, wherein the collaborative workspace comprises a plurality of collaborative object types, and the user can selectively view the collaborative workspace by object type.

34. The system of claim 1, wherein the collaborative workspace comprises a plurality of collaborative object types including at least a calendar object, and wherein the user can view the collaborative workspace calendar objects in a calendar view.

35. The system of claim 34, wherein the user can simultaneously view a collaborative workspace calendar view and the user's personal calendar.

36. The system of claim 35, wherein the user's electronic mail application is integrated with a personal information manager, the PIM including a calendar module, and wherein the user can elect to have the user's personal calendar view show both personal and collaborative workspace calendar items.

37. The system of claim 36, wherein the calendar view comprises calendar objects related to the collaborative workspace.

38. The system of claim 36, wherein personal items and collaborative workspace items are differentiated by their appearance.

39. The system of claim 1, wherein the collaborative workspace comprises a plurality of collaborative object types including at least a participants object, and wherein the user can view the collaborative workspace participants objects in a participants view.

40. The system of claim 39, wherein the user can simultaneously view a collaborative workspace participants view and the user's personal contacts.

41. The system of claim 39, wherein the user's electronic mail application is integrated with a personal information manager, the PIM including a contacts module, and wherein the user can elect to have the user's personal contacts view show personal and collaborative workspace contact items.

42. The system of claim 39, wherein the participants view can selectively display project participant information.

43. The system of claim 42, wherein project participant information includes at least one of participant status or participants postings information.

44. The system of claim 42, wherein personal contact items and collaborative workspace participant items are differentiated by their appearance.

45. The system of claim 1, wherein the collaborative workspace comprises a plurality of collaborative object types including at least a tasks object, and wherein the user can view the collaborative workspace task objects in a tasks view.

46. The system of claim 45, wherein the user can simultaneously view a collaborative workspace tasks view and the user's personal tasks.

47. The system of claim 45, wherein the user's electronic mail application is integrated with a personal information manager, the PIM including a tasks module, and wherein the user can elect to have the user's personal tasks view show personal and collaborative workspace task items.

48. The system of claim 45, wherein the tasks view can selectively display project tasks information.

49. The system of claim 48, wherein the project tasks information comprises at least one of task status or task responsibility.

50. The system of claim 42, wherein personal task items and collaborative workspace task items are differentiated by their appearance.

51. The system of claim 1, further comprising a relay box for supporting POP3 and SMTP protocols for receiving and sending electronic mail.

52. The system of claim 51, wherein the relay box is hosted on a relay box server, which is a server other than a server hosting the mail application of a project participant.

53. The system of claim 52, wherein the relay box is used when a participants own electronic mail server does not support POP3 access.

54. The system of claim 53, wherein a relay box is created and assigned as part of the user's registration prior to downloading the collaborative workspace module.

55. The system of claim 54, wherein the collaborative workspace protocol comprises means for dealing with users who require a relay box for the transfer of collaborative work space messages.

56. The system of claim 55, wherein the collaborative workspace module protocol relies on rich access to a user's mailbox and uses XML-tagged messages.

57. The system of claim 56, wherein the relay box configuration is used for users when rich access to the user's mailbox is not possible.

58. The system of claim 56, wherein the relay box configuration is used for users when the user retrieves their electronic mail using a standard POP3 protocol.

59. The system of claim 55, wherein the relay box comprises a local POP3 proxy that reads the electronic mail arriving at the user's inbox, and copies appropriate messages into the relay box's own data store for rich processing.

60. The system of claim 1, wherein the collaborative work space comprises collaborative objects that comprise structured items.

61. The system of claim 60, wherein the structured items comprise structured item data, and the collaborative workspace protocol supports changing the structured item data by sending XML-tagged electronic mail messages to other participants to update their local copy of the shared space with the changed data.

62. The system of claim 1, where the collaborative work space module enables participants to set operational preferences.

63. The system of claim 62, wherein the operational preferences include whether to send a periodic summary of the status of the project.

64. The system of claim 62, wherein the operational preferences include whether to automatically remove, from a user's inbox, messages associated with the collaborative workspace.

65. The system of claim 63, wherein the periodic summary may be sent on a daily, weekly, or monthly basis.

66. The system of claim 1, wherein the collaborative work space module converts an electronic mail platform object into platform independent format and comprises a schema for transfer.

67. The system of claim 66, wherein upon receipt, the recipient's collaborative workspace module converts the platform independent format/schema to the recipient's electronic mail platform.

68. The system of claim 66, wherein the objects comprise at least one of message objects, event objects, task objects, file attributes objects, and participant objects.

69. The system of claim 1, wherein a message caused to be sent by the collaborative workspace module adheres to MIME and S/MIME standards, includes data about a given collaborative workspace object and its attributes in a platform independent format.

70. The system of claim 69, wherein the collaborative work space module converts the data into an XML format with a platform neutral schema with all encompassing attributes before transmitting to a recipient.

71. The system of claim 70, wherein upon receipt, a recipient's collaborative work space module converts the object to the platform's format, reconciling differences in the naming and type of attributes.

72. The system of claim 1, wherein when the collaborative work space module resides on a server, and monitors a designated number of mailboxes.

73. The system of claim 72, wherein when a collaborative workspace message arrives at a mailbox the module transfers it to the a centralized collaborative workspace storage.

74. The system of claim 73, wherein if the same collaborative workspace message arrives at different user mailboxes on the same server, the module only processes one of the messages and ignores other copies of the message.

75. The system of claim 1, wherein only a project leader of a collaborative work space can invite and add new users.

76. The system of claim 75, wherein other users can propose new members to the project leader.

77. The system of claim 76, wherein a proposed new member message is sent as an XML-tagged electronic mail to the project leader, who can decide whether to invite the new member or not.

78. The system of claim 1, wherein the user may simultaneously view a message in an inbox view and in the context of the collaborative workspace to which it belongs in a project view, and further wherein the user may reply to the message from the inbox without having to separately access the project view.

79. The system of claim 78, wherein the reply message will automatically be placed in the context of the collaborative workspace.

80. The system of claim 79, wherein the message includes a collaborative workspace message designator message part and the collaborative workspace module monitors messages sent by the user.

81. The system of claim 1, wherein electronic mail users without the collaborative workspace module can participate in a collaborative workspace as an electronic mail only participant.

82. The system of claim 81, wherein an electronic mail only participant is enabled by replying to a collaborative workspace invitation without downloading the collaborative workspace module.

83. The system of claim 82, wherein an electronic mail only participant can later become a full participant by installing the collaborative workspace module.

84. The system of claim 81, wherein electronic mail only participants receive changes to a collaborative workspace via electronic mail messages.

85. The system of claim 81, wherein electronic mail only participants receive changes to a collaborative workspace optionally formatted in HTML with contextual information.

86. The system of claim 85, wherein when a new message is added to a discussion, electronic mail only participants are sent a message containing the subject and contents of the message, and the applicable list of messages in the discussion in which the message was created.

87. The system of claim 85, wherein when a new task is added to a task list, electronic mail only participants are sent a message containing the task and the applicable task list related information.

88. The system of claim 85, wherein when a new calendar item is added to a calendar, electronic mail only participants are sent a message containing the calendar item and applicable calendar related information.

89. The system of claim 85, wherein, when a new file is added to a file list, electronic mail only participants are sent a message containing the file and the applicable file list related information.

90. The system of claim 81, wherein electronic mail only participants may receive at their option a summary of what is new in a collaborative workspace.

91. The system of claim 81, wherein electronic mail only participants may respond to a message and the response will be placed in the collaborative workspace.

92. The system of claim 81, wherein in the participants view, electronic mail only participants appear in the view with a graphical designator showing that they are electronic mail only participants.

93. The system of claim 1, wherein collaborative workspace module enables secure platform independent replication of collaborative workspaces across entities.

94. The system of claim 93, wherein the collaborative workspace module uses public/private key technology to sign the collaborative workspace message part to guarantee its integrity and reliably determine the participant who originated it and optionally encrypt the data contents of the message depending on the security setting of the collaborative workspace.

95. The system of claim 1, wherein the collaborative workspace is embedded in the user's mailbox and securely replicated/synchronized to other participants' mailboxes in a platform independent fashion regardless of version or type of electronic mail application and version or type of operating system.

96. The system of claim 95, further comprising means for determining when the collaborative workspace is out of synch between two or more participants.

97. A computer-implemented electronic mail application and collaborative work space system comprising:
an electronic mail module comprising:
individual user mailboxes for each user, each mailbox comprising an inbox; and means for enabling the creation of at least one folder in a user's mailbox; and
a collaborative workspace module comprising:
means for enabling a first user to create at least one shared collaborative workspace and designate one or more other users for the shared collaborative workspace;
means for embedding the collaborative functionality in the user's electronic mail application; and
means for monitoring changes in the at least one collaborative workspace and propagating those changes into the collaborative workspace of another user of the collaborative workspace.

98. The system of claim 97, further comprising means for creating a folder in the mailbox of each shared collaborative workspace user, the folder corresponding to the shared collaborative workspace.

99. The system of claim 98, wherein each shared collaborative workspace folder comprises one or more sub-folders, the sub-folders comprising one or more of a calendar, tasks, participants, and files folder.

100. The system of claim 97, further comprising means for synchronizing changes to a shared collaborative workspace which is stored in the electronic mailboxes of two or more participants.

101. The system of claim 97, further comprising means for enabling a user to create a project and invite other participants, and in response thereto the system creating a folder in each participants' mailbox, performing an initial synchronization of each project folder, and periodically performing subsequent synchronizations of each project folder.

102. The system of claim 97, wherein a collaborative workspace folder is stored on participants' client terminals.

103. The system of claim 97, wherein a collaborative workspace folder is stored on a central server.

104. The system of claim 97, wherein a collaborative workspace folder is stored on a central server and on participants' client terminals.

105. The system of claim 97, wherein certain activity in the collaborative work space generates an electronic mail message relating to the activity, and the message 18 stored in the inbox of the recipients of the message and in project folders corresponding to the collaborative work space.

106. The system of claim 97, wherein certain activity in the collaborative work space generates an electronic mail message with an attachment, and wherein the attachments are stored in a files folder of the project folder.

107. The system of claim 97, wherein certain activity in the collaborative work space generates an electronic mail message with an attachment, and the message with an attachment is stored in the inbox of the recipients of the message wherein the attachments are stored in a files folder of the project folder.

108. The system of claim 97, comprising a common user interface for the electronic mail module and the collaborative workspace module.

109. The system of claim 108, comprising means for enabling a user to simultaneously view an inbox view and a project folder view.

110. The system of claim 97, comprising means for leveraging the existing messaging infrastructure, including protocols and servers, to replicate a collaborative space from an electronic mail environment in one computer to another electronic mail environment in another computer.

111. The system of claim 97, comprising means for using the existing messaging infrastructure of an electronic mail system for project management functionality including means for sending project management messages comprising project data and commands.

112. The system of claim 97, wherein the system appends a proprietary S/MIME part to outgoing messages, the part comprising information to: represent the contents of the message in a format independent of electronic mail platform; identify the collaborative workspace to which the message relates; securely identify the originator of the message; and securely encrypt the contents of the message.

113. The system of claim 112, wherein the S/MIME part is formatted in XML format independent of electronic mail platform.

114. The system of claim 113, wherein a receiving end decrypts the message, reads the S/MIME part, re-formats the message to match the receiver's electronic mail platform which may be different than the sender's electronic mail platform, and places the message in the intended collaborative workspace folder.

115. The system of claim 97, wherein the system comprises a collaboration protocol comprising commands and arguments, embedded in electronic mail messages as an S/MIME part for the purpose of maintaining two or more synchronized collaborative spaces.

116. The system of claim 97, comprising a collaboration protocol for inviting and “bootstrapping” new participants to an electronic mail-based collaborative work space.
